(19) United States
(12) Patent Application Publication
(10) Pub. No.: US 2010/0332273 A1
(43) Pub. Date: Dec. 30, 2010

(54) TOOLS FOR ASSISTING IN PETROLEUM PRODUCT TRANSPORTATION LOGISTICS

(75) Inventors: Jayanth BALASUBRAMANIAN, Fairfax, VA (US); Nicolas SAWAYA, New Brunswick, NJ (US); Kevin C. FURMAN, Houston, TX (US); Gary R. KOCIS, Vienna, VA (US); Michael F. MARGOLIES, Vienna, VA (US); Merryl J. MIRANDA, Falls Church, VA (US); Michael K. MCDONALD, Burke, VA (US); Jin-Hwa SONG, Whitehouse Station, NJ (US); Philip H. WARRICK, Oakton, VA (US)

Correspondence Address: ExxonMobil Research & Engineering Company, P.O. Box 900, 1545 Route 22 East, Annandale, NJ, 08801-0900, US

(73) Assignee: EXXONMOBIL RESEARCH AND ENGINEERING COMPANY, Annandale, NJ (US)

(21) Appl. No.: 12/822,695

(22) Filed: Jun. 24, 2010

Related U.S. Application Data
(60) Provisional application No. 61/220,159, filed on Jun. 24, 2009.

(51) Int. Cl. G06Q 10/00; G06Q 90/00

(52) U.S. Cl. 705/7; 705/500

(57) ABSTRACT

A tool to assist decision-making in the logistics of bulk product transportation. For example, the tool may be used to solve a problem involving the transportation and the inventory management of crude oil, in which the transportation of crude oil between supply ports and discharge ports are performed by a fleet of ships. The tool is capable of handling a typical petroleum product transportation problem, which can be quite complex. The tool uses advanced modeling and optimization technology to find a solution (either optimal or near optimal) for the allocation of bulk products, vehicle routing, vehicle scheduling, and/or bulk product blending operations.

### CROSS-REFERENCES AND RELATED APPLICATIONS

This application claims the benefit of provisional U.S. Patent Application No. 61/220,159 (filed 24 Jun. 2009), which is incorporated by reference herein in its entirety. This application is also related to U.S. application Ser. No. 12/292,600 entitled: “System for Bulk Product Allocation, Transportation and Blending” (by Song et al., filed on 21 Nov. 2008), which is incorporated by reference herein.

### TECHNICAL FIELD

The present invention relates to a system for planning the transportation and inventory management of petroleum products using a fleet of vessels.

### BACKGROUND

Current approaches to optimizing product transportation, whether for the movement of discrete products or bulk products, generally focus on transportation routing and/or vehicle scheduling and do not consider inventory management. In addition, these approaches typically require one or more of the following: a single homogeneous cargo or multiple cargos that cannot be mixed; the use of a homogenous fleet of vessels; travel between a single supply location and a single demand location; and a constant rate of supply and demand. Generally, these approaches also focus on minimizing cost rather than maximizing net profit.

TurboRouter® is a tool recently developed by the Norwegian Marine Technology Research Institute, MARINTEK Logistics. It performs vessel routing and scheduling calculations. The purpose of the tool is to allow a commercial shipping company, as opposed to a chartering party, to maximize the revenue obtained by shipping optional cargo in addition to contract cargos that must be shipped. This tool, however, does not account for inventory management or envision blending.

The shipping of ammonia has been addressed by M. Christiansen et. al., Decomposition of a combined inventory and time constrained ship routing problem, Transportation Science, 33(1): 3-16 (1999). This article poses the problem where inventory management and routing are constrained by time-window requirements and vessels are permitted to carry partial loads. A fleet of vessels transport a single bulk product between production and consumption harbors. The economic calculations of this approach oversimplify real problems and assume constant rates of production and consumption.

The minimum cost inventory routing problem for multiple bulk liquid products (which cannot be mixed) is addressed by D. Ronen, Marine inventory routing: shipments planning, Journal of the Operational Research Society, 53: 108-114 (2002). The vessels in this routing problem have multiple compartments and each vessel is restricted to loading and unloading at only one port. Additionally, this routing problem only allows a homogeneous pool of vessels.

There have been numerous publications in the field of vessel routing and scheduling. One survey article is Ship routing and scheduling: status and perspectives, Transportation Science, 38(1): 1-18, M. Christiansen, K. Fagerholt, and D. Ronen (2004). One overview article is Marine Transportation, Handbooks in Operations Research and Management Science: Transportation, M. Christiansen, K. Fagerholt, B. Nygreen, D. Ronen, edited by C. Barnhart and G. Laporte (2007).

One publication of note is Scheduling Ocean Transportation of Crude Oil, Management Science, G. G. Brown, G. W. Graves, D. Ronen, 33(3): 335-346 (1987). This paper addresses a crude oil marine transportation problem. The modeling problem described therein includes the following assumptions/simplifications: (1) each cargo (i.e., crude oil to be shipped) moves between a single loading port and a single discharging port; (2) the cargo shipped must always be a full vessel load (i.e., the cargo must be of a fixed size); and (3) each vessel is the same size. In addition, the objective function of the model is to minimize cost as opposed to net profit margin.

Another publication of note is Fleet management models and algorithms for an oil tanker routing and scheduling problem, H. D. Sherali, S. M. Al-Yakoob, M. M. Hassan, IIE Trans. 31: 395-406 (1999). This paper also addresses a crude oil marine transportation modeling problem. Again, the modeling problem characteristics are such that each voyage must consist of a single loading port and a single discharging port and each cargo must be a full vessel load. In addition, the objective is to minimize cost as opposed to net profit margin. The problem addressed in this paper is different from the preceding paper in that the vessels do not have to be the same size and there is an explicit treatment of vessel compartments.

There is a need in the art for an application that optimizes the total net profit associated with product allocation, transportation routing, transportation vehicle/route scheduling, and product blending. There is a need in the art for an application that perform this function in a manner that permits the movement of multiple types and qualities of bulk products, each with non-constant rates of supply (production) and demand (consumption), and each with different monetary values, from one or more supply locations to one or more demand locations, using a heterogeneous fleet of vessels, where each vessel may make multiple loads and discharges. In particular, such an application would provide significant financial benefits in the movement of petroleum and petroleum derived products from supply locations to demand locations.

### SUMMARY

The present invention provides a tool for determining bulk product allocation, transportation routing, vehicle/route scheduling, and/or blending operations. The tool is capable of handling a typical petroleum product transportation problem, which can be quite complex. A typical petroleum product transportation problem involves, inter alia, multiple supply locations each with multiple production products, each with different properties and different economic valuations, multiple demand locations each with multiple demand stream needs, each having different requirements and different price valuations for delivered products that meet the requirements, non-constant rates of supply and demand, and a heterogeneous fleet of transportation vehicles.

The present invention uses advanced modeling and optimization technology to find a solution (either optimal or near optimal) for the allocation of bulk products, vehicle routing, vehicle scheduling, and bulk product blending. In some cases, solutions to the model may be used to determine a transportation plan that includes one or more of the following: (i) the allocation of products produced at one or more supply locations to meet the consumption demands of one or more demand locations; (ii) a transportation routing schedule to implement the allocation plan; and (iii) a transportation vehicle/route schedule to implement the routing schedule. In a preferred embodiment, the transportation plan will also provide details for bulk product blending to be performed on-shore and/or onboard the vehicle during loading, transit, or discharge.

In one embodiment, the present invention provides a method for transporting bulk products, comprising receiving a data set comprising:

(a) an identification of a plurality of supply locations and a plurality of demand locations, each supply location having a supply stream of bulk products and each demand location having a demand stream for bulk products;

(b) for each supply location, data relating to the existing inventory, the anticipated production, the property specifications, and the monetary values of the bulk products from the supply stream;

(c) for each demand location, data relating to the existing inventory, the anticipated consumption, the property specification requirements, and the monetary values of the bulk products that meet the property specification requirements of the demand stream;

(d) identification of a fleet of vehicles that load bulk products at the supply locations and discharge bulk products at the demand locations;

(e) data relating to the availability and capacity of each vehicle in the fleet;

(f) data relating to the costs for transporting bulk products from the supply locations to the demand locations; and

(g) identification of one or more blending tanks, each located at a supply location or a demand location, for receiving and discharging bulk products.

A mixed integer non-linear programming (MINLP) model is populated using the data set. The MINLP comprises an objective function for net profit margin and a plurality of constraints. The objective function for net profit margin comprises the sum of the monetary values of the bulk products discharged directly to the demand streams from the vehicles, the sum of the monetary values of the bulk products discharged from each blending tank to a demand stream, minus the sum of the monetary values of the bulk products loaded from the supply streams, minus costs related to the transportation of the bulk products between the supply locations and the demand locations, minus costs related to the use of each blending tank for receiving and discharging bulk products. In some cases, the objective function further comprises the sum of the inventory holding costs. The constraints include one or more non-linear terms (e.g., bilinear terms) relating to the quantity(ies) and/or property(ies) of blending tank content.

The MINLP model is solved for maximizing the objective function for net profit margin. Based on the solution obtained, one or more bulk products are physically transported to a demand location, or from a supply location, or both. In some cases, the method further comprises, based on the solution obtained, physically transferring a bulk product into a blending tank containing another bulk product, and blending the bulk products in the blending tank to form a new blended bulk product. The bulk product may be transferred into the blending tank from any of various sources, including a vehicle, pipeline, or another tank.

In another embodiment, the present invention provides an optimization apparatus for determining the transportation of bulk products according to the above-described method. In another embodiment, the present invention provides a program storage device readable by a machine, tangibly embodying a program of instructions executable by the machine to perform the above-described method steps for determining the transportation of bulk products.

In another embodiment, the present invention provides a method of operating an optimization apparatus that comprises a memory device, a modeling application, and a solver. The optimization apparatus is operated by: (I) loading into the memory device a data file containing the above-described data; (II) executing the modeling application to populate the above-described mixed integer non-linear programming model using the data file; and (III) running the solver to obtain a solution to the mixed integer non-linear programming model for maximizing the objective function for net profit margin. The apparatus may have one or more solvers, which may be used in combination (e.g., sequentially or iteratively).

### BRIEF DESCRIPTION OF THE DRAWINGS

FIG. 1 represents a transportation problem involving a set of supply ports, a set of demand ports, and a fleet of vessels that can be modeled by the present invention.

FIG. 2 shows a schematic diagram of a demand port that can be modeled by the present invention.

FIG. 3 shows a time-space network formulation in which a vessel is a commodity and nodes represent a possible visit to a port at a particular time.

FIGS. 4 and 5 show flowcharts illustrating a solution algorithm.

### DETAILED DESCRIPTION

“Allocation,” when used with respect to the movement of product from supply locations to demand locations, refers to determinations regarding the identity and/or amount of supply-side product to be transported and demand side product needs to be met.

“Bulk product” means any product that is unbound and substantially fluid as loaded; in other words, it is in a loose unpackaged form. Examples of bulk products include petroleum products.

“Code” embraces both source code and object code.

“Computer-readable medium” includes any mechanism for storing or transmitting information in a form readable by a computer. For example, a computer-readable medium includes, but is not limited to, read only memory (“ROM”), random access memory (“RAM”), magnetic disk storage media, optical storage media, flash memory devices, etc.

“Discharge location,” “demand location” and “destination location,” as used synonymously herein, refer to a place where transported cargo is unloaded. Similarly, “discharge port,” “demand port” and “destination port” are each synonymous terms that refer to a port where cargo is discharged.

“Load location,” “supply location” and “origin location,” as used synonymously herein, refer to a place where transported cargo is loaded. Similarly, “load port,” “supply port,” and “origin port” are each synonymous terms that refer to a port where cargo is loaded.

“Transportation routing,” when used with respect to the movement of product from supply locations to demand locations, refers to determinations regarding the number of trips, sequence of stops, and assignment of vessels to perform a product allocation.

“Transportation vehicle/route scheduling” refers to the assignment of time to each activity to perform a plan for transportation routing.

“Vehicle” means any vessel, barge, plane, train, truck or other mechanical means of transportation.

“Vessel” means any ship, barge or other water faring vehicle.

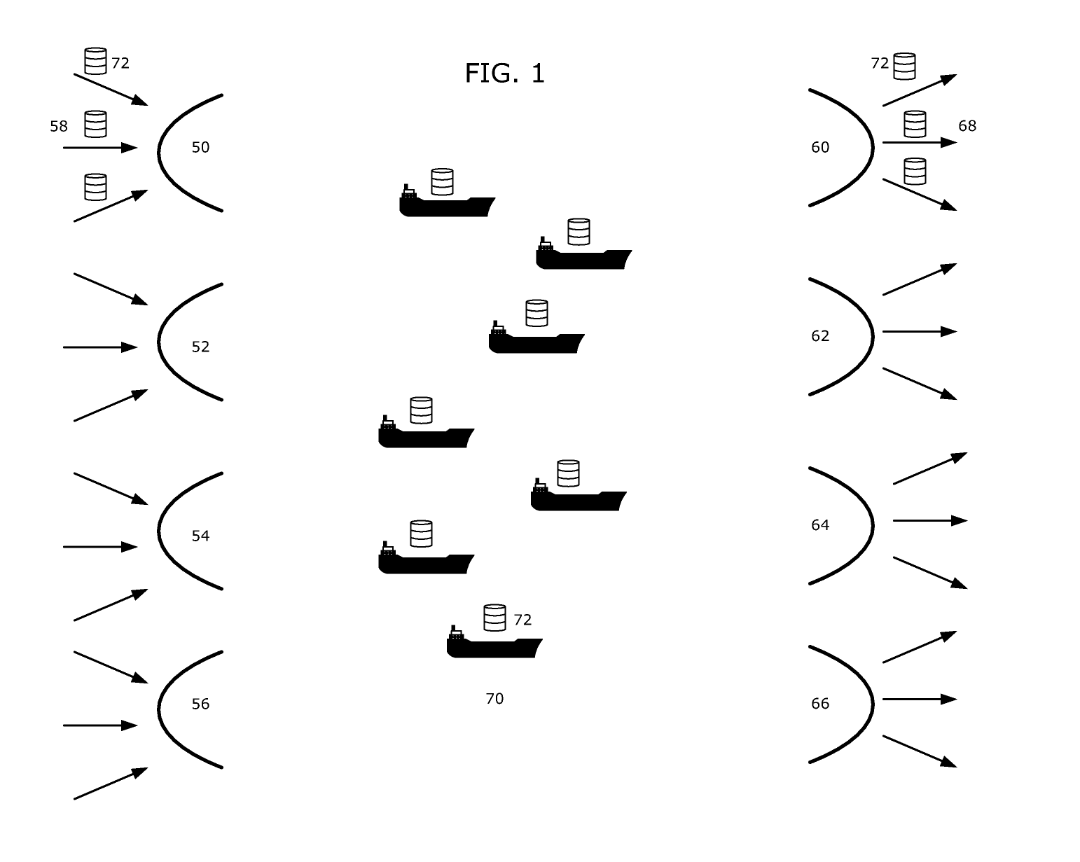

An example of a transportation problem that can be modeled by an embodiment of the present invention will now be described. FIG. 1 shows a schematic illustration representing a problem involving the transportation of petroleum products (i.e., bulk products represented as barrels 72). Petroleum products need to be transported from the supply ports (i.e., supply locations) 50, 52, 54, and 56 to the demand ports (i.e., demand locations) 60, 62, 64, and 66. A fleet 70 of vessels are available to physically transport the petroleum products from the supply locations to the demand locations.

Each supply location can produce multiple supply streams (represented by arrows 58) of bulk product, each stream having its own properties and monetary valuation based thereon, and each stream having its own accumulated inventory, storage constraints and production profile. In addition, each demand location can require multiple demand streams (represented by arrows 68) of bulk product, each stream having its own property range requirements and property based monetary valuation for actual bulk products that are delivered to meet those requirements, and each stream having its own inventory, storage constraints and consumption schedule. The different bulk product streams are loaded into separate segregations of the same transportation vehicle. However, the different bulk products can be blended (on-shore and/or onboard a vehicle during loading, discharge, or transit), in a manner that changes the properties of one or more of the loaded bulk products and benefits the overall value of bulk products delivered to meet the demand location requirements. Each of these points is further elaborated upon below.

Each supply location may produce multiple bulk products. In other words, each supply location can produce multiple streams of different types and/or grades of bulk product. Thus, for example, the bulk product produced at one supply location might be a single stream of a specific grade of gasoline. Alternatively, the bulk product produced at the supply location might be multiple streams of different grades of vacuum gas oil (VGO), such as low sulfur VGO and high sulfur VGO. Preferably, the user identifies each supply location to be considered by the modeling tool and its corresponding production streams.

Each production stream has its own properties and property based monetary valuation. The properties may be chemical or physical, but typically relate to chemical composition of the production stream. For example, the value of fuel products, such as VGO and gasoline, typically rise or fall based on composition (e.g., nitrogen content, sulfur content, etc.). Preferably, the user designates each supply stream monetary value based on current prices in the local spot market for the supply location.

Each production stream also has its own accumulated inventory, preferred minimum and maximum storage constraints and anticipated production schedule. The production profile does not have to be constant or continuous. The modeling tool considers these factors when developing the allocation, transportation routing and transportation vehicle/route schedules. Preferably, the user designates the existing inventories, preferred storage constraints and anticipated production schedule for each production stream.

Each demand location may consume multiple bulk products. In other words, each demand location may consume multiple streams of different types and/or grades of bulk product. Thus, for example, the bulk product consumed by one supply location might be a particular grade of gasoline. Alternatively, the bulk product consumed by the demand location might be multiple streams of different grades of VGO. Preferably, the user identifies each demand location to be considered by the modeling tool and its corresponding demand streams.

Each demand stream has its own property range requirements and property based monetary valuations for actual bulk products that are delivered to meet those requirements. The properties may be chemical or physical, but typically relate to the chemical composition of the delivered bulk product. For example, fuel products, such as different grades of gasoline or VGO, must meet the specific compositional range requirements of a demand stream (e.g., nitrogen content, sulfur content, etc.) to be acceptable. However, all fuel products that meet the requirements are not the same and the actual value of any particular product that meets the requirements may vary depending upon where, within the required property ranges, the properties of the particular product actually fall. Accordingly, a base monetary value is typically set for an average product that meets the property range requirements of the demand stream. In addition, property based adjustment factors are provided to adjust the base monetary value for actual bulk products that are delivered based on their properties relative to the properties of the average product. Preferably, the base monetary value and property adjustment factors are input by the user based on value assessments in the local spot market for the demand location.

Each demand stream also has its own accumulated inventory, preferred minimum and maximum storage constraints and anticipated consumption schedule. The consumption profile does not have to be constant or continuous. The modeling tool considers these factors when developing the allocation, transportation routing and transportation vehicle/route schedules. Preferably, the user designates the existing inventories, preferred storage constraints and anticipated consumption schedule for each demand stream.

The vehicles may be homogeneous or heterogeneous in capacity and cost. In one embodiment, the vehicles are heterogeneous in both capacity and cost. The vehicles utilized in the invention will typically contain multiple segregations to permit the transport of multiple products without unintentionally compromising the compositional integrity of the products. Accordingly, each bulk product that is loaded from each supply location is transported in one or more separate segregations of the same transportation vehicle.

The different bulk products loaded onto each transportation vehicle can be blended as the products are loaded onto or discharged from the transportation vehicle, or during vehicle transit, in a manner that changes the properties of one or more of the loaded bulk products and benefits the overall value (e.g., monetary value) of bulk products delivered to meet demand location requirements. For example, different products can be blended by simultaneous load or discharge, at defined rates, through the same load or discharge tube. In other words, by opening and closing valves for different product streams leading to a common load or discharge tube, in a controlled manner, products can be mixed in the tube at different rates.

The modeling tool can also take into consideration the availability of on-shore blending for bulk products to meet the specification/property range requirements of the demand streams. This on-shore blending may occur before loading of bulk products onto a vessel (i.e., at a supply location), or after unloading from a vessel (i.e., at a demand location), or both.

In certain embodiments, one or more demand locations have at least one blending tank for receiving bulk products from a vessel. For example, two or more of the vessels may discharge different bulk products (simultaneously or consecutively) into a blending tank(s) to form a new blended bulk product for discharge to a demand stream. The blended bulk product is fed into the demand stream to increase the overall value of the bulk products being discharged to the demand streams.

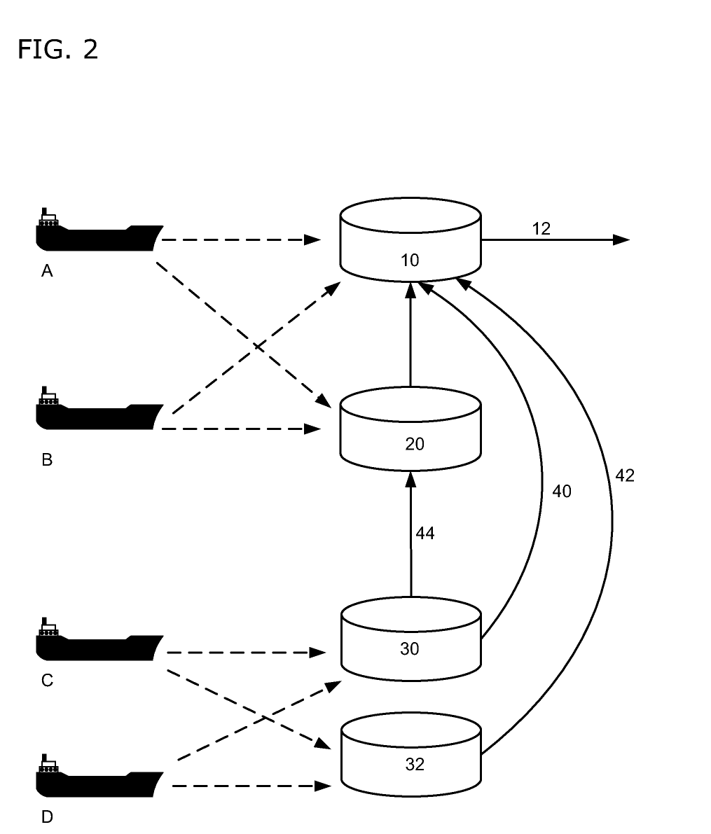

For example, FIG. 2 shows a demand port having a discharge tank 10 for receiving on-specification bulk products for discharge to a demand stream 12. The demand port also has a user-company owned blending tank 20 for blending bulk products to the property specifications required by demand stream 12. The blended bulk products from blending tank 20 feeds into discharge tank 10. FIG. 2 also shows blending tanks 30 and 32 located off-site that are available for leasing.

Vessel A arriving at the demand port can unload its bulk products directly to the demand stream 12 via discharge tank 10, into blending tank 20 for blending, or both. Likewise, Vessel B arriving at the demand port can unload its bulk products directly to the demand stream 12 via discharge tank 10, into blending tank 20 for blending, or both. The modeling tool may provide a blending plan recommending that Vessel A discharge at least some of its bulk products into blending tank 20, and Vessel B discharge at least some of its bulk products into blending tank 20 to form a blended bulk product that meets the specification requirements of demand stream 12. The blended bulk product is then fed into discharge tank 10 for discharge into the demand stream 12.

In a similar manner, off-site tanks 30 and 32 can be leased for blending bulk products unloaded by Vessels C and D. The blended bulk products in these leased tanks can be moved (e.g., by barge or pipeline) to blending tank 20 for further blending or to discharge tank 10 for discharge to demand stream 12. The model may also take into consideration the costs associated the leasing of the off-site tanks and the transport of bulk products from the leased tanks. The model may also take into consideration the availability of spot purchases of bulk products from 3rd parties for feeding into discharge tank 10, blending tank 20, and/or the leased tanks. In such cases, bulk products from a vessel may be blended with bulk products from spot purchases to form the blended bulk product. In alternate embodiments, the on-shore blending may take place at one or more supply locations, or at both supply and demand locations.

In addition, due to the flexibilities in the compartments of vessels, a vessel may load several products and move and blend them into several new products during transit. Blended products may be prepared for several demand streams, depending upon the economics and consumption rates of the demand streams. The value of a blended product is its value, in view of its properties, to the demand port where the product is delivered—which can be assessed, for example, based on the local spot market for the demand port. An example includes blending a lower value product (e.g., high sulfur VGO (HSVGO)), which is not acceptable for many VGO demand streams, with a high quality product (e.g., low sulfur VGO (LSVGO)), to create a new product stream that is acceptable. Therefore the modeling tool not only saves transportation costs, but can also create value by reducing quality giveaway.

The modeling tool may account for one or more, and preferably all, of the following: (i) the availability, cost, capacity and current cargo of each vehicle in an available fleet; (ii) the relative separation, in travel time and/or distance, of each supply location and demand location from one another and travel cost for traversing the same; (ii) any vehicle size restrictions, loading restrictions and/or discharge restrictions at each supply location and demand location; (iv) holding costs, if any, for storing bulk product at the supply locations, demand locations and/or on-board the transportation vehicles; and (v) the availability of spot market purchases to augment supply deficits and/or spot market sales to deplete supply overages. Each of the additional points is discussed in more detail below.

First, when assigning specific vehicles to perform specific transportation routes, factors considered by the modeling tool may include the time availability, carrying capacity, associated transportation costs (e.g., flat rate, overage costs, demurrage costs, etc.), and current cargo for each vehicle in an available fleet of vehicles. The vehicles may be selected from spot vehicles, term vehicles or any mixture thereof. Less desirably, if the available fleet of vehicles is neither fully known nor anticipated general information regarding a desired class of vehicles (e.g., an Aframax or a Panamax vessel) can be utilized. Preferably, this information is input by the user for each chartered or anticipated vehicle in the available fleet.

Second, when designing transportation routes, factors considered by the modeling tool may include the relative geographic location, in time and/or distance, of each supply location and each demand location from one another and the relative cost of traversing the same. Preferably, the user inputs information regarding the relative separations for each location and relative travel cost (e.g., the Worldscale rate for the trade route). Preferably, this information is input by the user for each supply location, demand location and each travel leg between locations.

Third, when designing transportation routes and assigning specific vehicles to specific routes, factors considered by the modeling tool may include any vehicle size restrictions, loading restrictions and/or discharge restrictions at each supply location and demand location. For example, some ports have inlet draft and outlet draft restrictions, load and/or discharge blackout days, and minimum and maximum amounts of cargo that can be loaded and/or discharged. Preferably, any such restrictions are input by the user for each supply location and demand location.

Fourth, holding costs are generally incurred for every unit of bulk product production that is not moved immediately. Holding costs are also incurred for every unit of bulk product delivered that is not consumed immediately. Holding costs are also incurred for every unit of bulk product that sits in a vehicle without being loaded, unloaded, or actively transported. There may be a single universal holding cost applicable for all holding scenarios. Alternatively, there may be one holding cost for all supply locations, one holding cost for all demand locations, and one holding cost for all transportation vehicles. Alternatively, there may be a separate holding cost for each demand location, each supply location and each transportation vehicle. Holding costs are preferably input by the user. Holding costs can be incurred at the supply side, demand side, or on-board a vessel. The modeling tool may take into account one or more of the inventory holding costs.

Fifth, and finally, there may be instances where the production at the supply locations under consideration either cannot meet, or exceeds, the consumption at the demand locations. In such cases, factors considered by the model may include the availability of bulk product purchases on the spot market to augment production and/or the availability of bulk product sales on the spot market to deplete production. Preferably, the user specifies the identity, location, amount and price of bulk products that can be purchased and/or sold on the spot market.

With respect to the use of blending tanks for on-shore blending, factors considered by the modeling tool may include one or more of the following: tank capacity, tank leasing costs, tank location, bulk product compatibilities or restrictions, demand stream or supply stream compatibilities or restrictions, content specifications, initial inventory, mapping to valuation streams, and content specification constraints. There may also be additional factors to be considered for leased tanks (examples to be provided below in the worksheet details). Decision variables relating to the use of blending tanks may include, for example: binary decisions about whether to use a particular tank, binary decision about whether to lease a tank, discharge amount to a blending tank from a vessel, discharge amount from a blending tank to a demand stream, amount of spot market purchases discharged to a blending tank, or inventory levels in the blending tanks

### Implementation for Marine Transportation

The transportation of the bulk products involves a physical movement of the bulk product from one location to another. The vehicular mode of bulk product transportation is not restricted and may be vessel, plane, train, truck or any combination thereof. However, in a preferred embodiment, the bulk products are transported by vessel. Accordingly, in this preferred embodiment, each vehicle is a vessel, each route to be performed is a voyage, each supply location is a supply port and each demand location is a demand port.

In a marine context, factors that may be taken into account by the modeling tool of the present invention include one or more of the following: (i) existing inventory, anticipated production, properties and monetary value of the bulk product(s) produced at each supply port; (ii) existing inventory, anticipated consumption and property requirements of bulk product(s) needed at each demand port and the monetary value of bulk products that meet the property requirements; and (iii) opportunities to blend different bulk products to benefit the overall value of delivered bulk products. Preferably, the model takes into account items (i) and (ii) above are taken into account. Ideally, the model takes into account each of items (i), (ii) and (iii).

More particularly, each supply port can produce multiple supply streams of bulk product, each stream having its own properties and monetary valuation based thereon, and each stream having its own accumulated inventory, storage constraints and production schedule. In addition, each demand port can require multiple demand streams of bulk product, each stream having its own property range requirements and property based monetary valuation for actual bulk products that are delivered to meet those requirements, and each stream having its own inventory, storage constraints and consumption schedule. Finally, different bulk product streams are loaded into separate segregations of the same transportation vehicle. However, the different bulk products can be blended (on-shore or onboard a vehicle during loading, discharge, or transit) in a manner that changes the properties of one or more of the loaded bulk products and benefits the overall value of bulk products delivered to meet demand location requirements.

With respect to the present invention being implemented for a marine context, other factors that may be taken into consideration include one or more, and preferably all, of the following: (i) the availability, cost, capacity and current cargo of each vessel in an available fleet; (ii) the relative separation, in travel time and/or distance, of each supply port and demand port from one another and cost for traversing the same; (iii) any vessel draft restrictions, loading restrictions and/or discharge restrictions at each supply location and demand location; (iv) the holding costs, if any, for storing bulk product at the supply ports, demand ports and/or on-board the vessels; locations; and (v) the availability of spot market purchases to augment supply deficits and spot market sales to deplete supply overages.

### Implementation for Bulk Products

The types of bulk product transported in the problem to be solved are not restricted. However, in a preferred embodiment, the bulk products are petroleum products, which may be selected from one or more grades of petroleum and/or products derived from petroleum. In a more preferred embodiment, the bulk products are selected from one or more grades of the following products: crude oil; gasoline; gas oil; condensate; distillate; and intermediate petrochemical feed stock.

### Work Process Using the Modeling Tool

The modeling tool of the present invention may be used to make various decisions, including determining bulk product allocation, transportation routing, transportation vehicle/route scheduling, and blending plans. In one embodiment, the work process for operating the modeling tool of the present invention comprises three steps.

The first step is entering data into a database. The database may be integral to, or interfaces with, a computer application. The data typically comprises one or more, and preferably all, of the following: (i) information regarding each supply stream at each supply location to be considered and its properties, monetary valuation, accumulated inventory, storage constraints and production schedule; (ii) information regarding each demand stream at each demand location to be considered and its property range requirements, property based monetary valuation for actual bulk products that are delivered to meet those requirements, inventory, storage constraints and consumption schedule; (iii) information regarding the availability, cost, capacity and current cargo of each vehicle in an available fleet; (iv) information regarding the relative separation, in travel time and/or distance, of each supply location and demand location from one another and cost for traversing the same; (v) information regarding vehicle size restrictions, loading restrictions and discharge restrictions at each supply location and demand location; and (vi) information regarding holding costs, if any, for storing bulk product at the supply locations, demand locations and/or on-board the transportation vehicles; and (vii) information regarding the availability of spot market purchases to augment supply deficits and spot market sales to deplete supply overages. Additional data that may be contained in the database are explained in the worksheet descriptions below.

The second step in the process is performing the mathematical and/or data processing operations for formulating and/or populating the model, and then solving the model. This process may be performed by a computer application. One or more of the following parameters may be taken into account in formulating, populating, and/or solving the model: (i) existing inventory, anticipated production, properties and monetary value of bulk product(s) produced at each supply location, (ii) existing inventory, anticipated consumption and property requirements of bulk product(s) needed at each demand location and the monetary value of bulk products that meet the property requirements, and, optionally, (iii) opportunities to blend different bulk products to benefit the overall value of delivered bulk products.

The present invention contemplates various approaches to solving the model. If no feasible solution is found, then the user may restart the process using an altered data set or permit more time for finding a solution. Alternatively, the user can view the highest ranked (i.e., least penalized) infeasible solution. The model may not find a feasible solution if either (a) no feasible solution exists or (b) the solution calculation is prematurely terminated and, in such cases, the solution found will be the best solution given the data set and time permitted. The application should flag any solution that is not feasible and the reason for the infeasibility.

The user may review the solution results to insure that the results are acceptable. If the results are not deemed satisfactory, or if the user wants to perform an additional what-if analysis, then the user can restart the process with an adjusted data set. Based on the solution obtained, one or more of the following may be determined or planned: bulk product allocations, transportation routing, transportation vehicle/route scheduling, and blending of bulk products within a within a planning horizon, in order to maximize total net profit margin.

For example, the modeling tool may specify a recommended transportation program detailing each of the following: (i) the allocation of products produced at one or more supply locations to meet the consumption demands of one or more demand locations; (ii) a transportation routing schedule to implement the allocation plan; and (iii) a transportation vehicle/route schedule to implement the routing schedule. In a preferable embodiment, the transportation program will also detail (iv) a schedule for blending product on-shore and/or onboard a vehicle during product loading, transit, or discharge. The results can then be stored in the form of one or more reports, spreadsheets, etc.

The third step in the process is to enact the plan. In other words, the solution will designate product to be moved between different locations, routes to be performed to move the product, vehicles to be utilized on each route, and specific blending operations to be performed during the loading, discharge and/or movement of bulk product by each vehicle. Each designated vehicle will be assigned the identified route, physically load the designated products at the designated times from each supply port on the route, physically perform any designated blending operations (on-shore and/or onboard a vehicle during loading, discharge, or transit), and physically deliver the designated products at the designated times to the designated demand ports for the designated demand streams. Also, in some cases, enacting the plan involves physically blending bulk products in on-shore blending tanks

### Meteoroid—Introduction

This example describes one particular embodiment of the invention and its use in finding a solution (either optimal or near optimal) for the allocation, transportation routing, vessel/voyage scheduling and blending planning to maximize total net profit margin in the movement of VGO from supply ports to demand ports to feed FCC units within a given planning horizon. In this embodiment, each supply port produces one or more streams of VGO, each stream having an independent composition and/or property set, and each stream having an independent inventory and production schedule. Similarly, each demand port requires one or more streams of VGO for its FCC units, each stream having independent ranges of property requirements, and each stream having an independent inventory and consumption schedule. In addition, each load and discharge port has unique physical and temporal restrictions for vessel usage and each vessel has unique size, availability, capacity, and cost parameters. The allocation, transportation routing, voyage/vessel scheduling and blending are optimized, in view of all of these factors, to meet the demand consumption using the load port production in a manner that maximizes total net profit. For reference purposes, the particular computer application described in this embodiment is nicknamed “METEOROID.”

### Meteoroid—Hardware and Software Requirements

METEOROID has some basic preferred hardware and software configurations. First, METEOROID prefers a relatively modern processor (e.g., a 3 GHz processor with 2 GB of RAM). Second, METEOROID prefers a relatively modern operating system such as Microsoft Windows XP Professional (v. 2002, SP1). Third, since METEOROID is an AIMMS modeling application, it requires a licensed version of a relatively modern AIMMS modeling system (e.g., AIMMS version 3.6.2). AIMMS, a product of Paragon Decision Technology B.V., is an advanced development system for building optimization based decision support applications. AIMMS provides a mathematical modeling language that is designed for the development of modeling applications, a graphical interactive user interface that developers can tailor for the applications, and an ability to link the applications to optimization solvers (e.g., CPLEX, XPress, XA, KNITRO, etc.). Fourth, METEOROID prefers a relatively modern version of Microsoft Excel (e.g., Microsoft Office Excel 2003). METEOROID uses an Excel workbook for data entry and, in addition, the results from the METEOROID model can be stored in Excel format. Fifth, and finally, although programs written in AIMMS can perform some calculations, METEOROID requires a solver (e.g., CPLEX, XPress, XA, KNITRO, etc.) to solve the programming models in the application.

### Meteoroid—Work Process

The basic process for METEOROID beings with the user entering the necessary data into an Excel workbook. Second, the user causes the computer to read the data from the Excel workbook into a METEOROID AIMMS application. Third, the user examines the data and validates data transfer using an AIMMS interface page. If errors in the data exist, the user restarts the process. Alternatively, the user can make changes directly to some of the data through the AIMMS interface pages, however, such changes are not saved in the Excel workbook for future program runs. Fourth, the user executes the optimization model on the computer either through an exact method or through various heuristic options. If the model does not have a feasible solution, then the user restarts the process using an altered data set. Alternatively, the user can view the highest ranked (i.e., least penalized) infeasible solution. Fifth, the user reviews the results through various AIMMS interface pages. If the results are not satisfactory, or the user wants to perform a what-if analysis, the user restarts the process using a different data set. If the reports are satisfactory, then the user saves and/or generates reports that record the solution. The user then enacts the solution. The ultimate result of the process is the assignment and, thereby, movement of vessels from various locations to load, move and discharge product from supply locations to demand locations and the transformation of products through blending during loading, discharge, or transportation.

METEOROID uses an Excel workbook for data entry. In general, the data comprises information regarding identity, physical restrictions, production schedule and inventories of supply ports, the identity, physical restrictions, consumption schedule and inventories of demand ports, variations in stream value based on composition and/or properties and the physical parameters, capacity, cost and availability of transportation vessels.

The Excel workbook includes the following worksheets: (i) a Start worksheet that contains preliminary inputs regarding the planning horizon, optional parameters, penalties and inventory holding cost; (ii) a Port worksheet that defines the load and discharge ports to be considered in the modeling problem and physical and temporal restrictions for the same; (iii) a Product-Spec_Def worksheet that sets forth the properties used to assign a monetary value to the bulk product being transported (e.g., VGO for FCC units), the direction in which changes in such properties affect monetary value and typical property values for different grades of the bulk product; (iv) a Product-Supply worksheet that identifies the supply streams to be considered in the modeling problem, properties regarding the same and the monetary valuation of the same; (v) a Product-Demand worksheet that identifies the demand streams to be considered in the modeling problem, property range requirements for the same, the monetary valuation of a typical stream of the required grade that meets the range requirements and property specific monetary adjustment factors to determine the monetary valuation of actual streams delivered to meet the range requirements; (vi) a Production worksheet that details projected production/inventory for each supply stream during the production horizon assuming no inventory is moved; (vii) a Consumption worksheet that details the projected consumption/inventory for each demand stream during the consumption horizon assuming no additional inventory is delivered; (viii) a Legs worksheet that allows a user to forbid voyage legs between specified ports; (ix) a Ship worksheet that identifies the spot vessel charters that have been made and that are of interest, as well as the physical and cost parameters for the same and any relevant port restrictions for the same; (x) a Time worksheet that records the average days it takes a vessel to transit each potential leg in a voyage; (ix) a Cost worksheet that records a leg rate for each potential voyage leg between ports; (xii) a BlackOut worksheet that records any days within the relevant production horizon or consumption horizons in which a load port will not be available for cargo loading or a discharge port will not be available for cargo discharge, respectively; (xiii) a Tank_Details worksheet containing information related to the blending tanks; and (xiv) a Tank_Specs worksheet containing information related to the contents of the blending tanks Entering data into the twelve worksheets for the first time can be work intensive. However, thereafter, the job is much easier since much of the data is relatively static (e.g., travel time between ports, the physical characteristics of each available vessel, port constraints, etc.). The user starts with a copy of an existing data file and updates dynamic information therein to the extent that changes have occurred. Preferably, this is done routinely as part of a regular process.

The Start worksheet contains preliminary inputs regarding the planning horizon, optional parameters, penalties, and inventory holding costs. The data in the Start worksheet includes the following:
a. “Number of Outlook Days”—The number of days in the planning period.
b. “Number of Rollover Days”—Production must be produced and moved before it can meet consumption. Therefore, there should be an offset in the production and consumption horizons considered. This offset is the number of rollover days.
c. “Production Start Date”—The first day in the production horizon. This is the start date for the planning period.
d. Production End Date”—The last day in the production horizon. Preferably, this date is automatically projected by adding the number of outlook days to the production start date and deducting the number of rollover days.
e. “Demand Start Date”—The first day in the consumption horizon. Preferably this date is automatically projected by adding the number of rollover days to the production start date.
f. “Demand End Date”—The last day in the consumption horizon. Preferably this date is automatically projected by adding the number of rollover days to the production end date. This date represents the end of the planning period.
g. “Minimum Total VGO Transported”—An optional field where the user can input, if desired, a minimum amount of product, in ktons, to be transported in the problem solution.
h. “Minimum Number of Ships”—An optional field where the user can input, if desired, the minimum number of vessels to be utilized in the problem solution.
i. “Maximum Number of Ships”—An optional field where the user can input, if desired, the maximum number of vessels to be used in the problem solution.
j. “Maximum Cost per Ton of VGO”—An optional field where the user can input, if desired, the maximum vessel transportation cost, in U.S. k$/ton, permitted in the problem solution.
k. “Load Side Slack Penalty”—A problem may not have a feasible solution. If so, it may be desirable to view ranked infeasible solutions. A load side slack penalty can be used to evaluate infeasible solutions. A penalty value is assigned for every kton of production inventory in an infeasible solution that is not either stored in supply side inventory holding or moved to a discharge port. For example, if the load side slack penalty is 1, and a load port generates 20 ktons of VGO during a production horizon and can only store 10 ktons, and the solution is only able to transport 9 of the remaining 10 ktons to discharge ports, then one ton [i.e., (20−10)−9=1] remains unaccounted for and the load side slack penalty will be 1 (i.e., 1×1=1).
l. “Discharge Side Slack Penalty”—Again, a problem may not have any feasible solutions. If so, it may be desirable to view ranked infeasible solutions. A discharge side slack penalty can also be used, either alone or in conjunction with a load side slack penalty, to evaluate infeasible solutions. A penalty value is assigned for every kton of consumption demand in an infeasible solution that is not either met through existing demand side inventory holding or through additional inventory delivery. For example, if the discharge side slack penalty is 3, and a discharge port demands 10 ktons of VGO during a consumption horizon and only has 2 ktons of VGO in existing storage, and the solution is only able to deliver 7 ktons of additional VGO, then one ton of demand [i.e., (10−2)−7=1] is not met an the discharge side slack penalty is 3 (i.e., 1×3=3).
m. “Inventory Holding Cost at Load Port”—This is an assigned value, in U.S. $/kton, incurred for every day inventory sits in a storage tank at a supply port.
n. “Inventory Holding Cost at Discharge Port”—This is an assigned value, in U.S. $/kton, for every day inventory sits in a holding tank at a demand port.
o. “Inventory Holding Cost on Ship”—This is an assigned value, in U.S. $/kton, for every day inventory sits in a transportation vessel.

The Port worksheet defines the load ports and discharge ports to be considered by the modeling tool, and physical and temporal restrictions for the same. The Port worksheet includes a table for user-company load ports and a table for 3rd party load ports. For each, the user inputs the following information:
a. “Load Port”—the name of each load port;
b. “On/Off”—a “1” is entered for each load port should be considered and a “0” is entered for each load port should not be considered;
c. “Load Port w/ Draft”—the load port name is re-entered for each load port that contains draft restrictions (a blank indicates that no such restrictions exist); and
d. “No Aframax Load Ports”—the load port name is re-entered for each load port that does not serve Aframax class vessels (a blank indicates that no such restrictions exist).

The Port worksheet includes a table for spot market purchases. In this table, for a spot purchase port (USSPOT_Pur), the user inputs the following information:
e. “Spot purchase (by barge)”—the name, which may simply be a place holder, of each anticipated spot purchase port where spot purchases might be made to augment production (spot market purchases are generally handled by barge); and
f. “On/Off” (Spot Market Purchase)—a “1” is entered by the spot purchase port if the production on the load supply side can be augmented with spot market purchases and a “0” is entered if such purchases are not an option.

The Port worksheet includes a table for user-company discharge ports and a table for 3rd party discharge ports. For each, the user inputs the following information:
g. “Discharge Port”—the name of each discharge port;
h. “On/Off”—a “1” is entered for each discharge port that should be considered and a “0” is entered for each discharge port that should not be considered;
i. “Discharge Port w/ Draft”—the discharge port name is re-entered for each discharge port that contains draft restrictions (a blank indicates that no such restrictions exist); and
j. “No Aframax Discharge Ports”—the discharge port name is re-entered for each discharge port that does not serve Afromax class vessels (a blank indicates that no such restrictions exist).

The Port worksheet includes a table for spot market sales. In this table, for a spot sale port (USSPOT_Sale), the user inputs the following information:
k. “Spot sale (by ship)”—the name of the anticipated spot sale port where excess production might be sold on the spot market (spot market sales are generally handled by ship);
l. “On/Off”—a “1” is entered for the spot sale port if production can be depleted by spot market sales and a “0” is entered if this should not be an option;
m. “Spot sale (by ship) w/ draft”—the spot sale port name is re-entered if the spot sale port that has draft restrictions (a blank means no such restrictions exist); and
n. “No Aframax Spot Sale (by ship)”—the spot sale port name is re-entered if the spot sale port that does not serve Aframax class vessels (a blank means no such restriction exists).

The Port worksheet includes a table for user-company load port properties and a table for 3rd party load port properties. For each, the user inputs the following information:
o. “Load Port”—the name of each load port;
p. “Min Flow”—the minimum amount, in ktons, that each load port will permit a vessel to load;
q. “Max Flow”—the maximum amount, in ktons, that each load port will permit a vessel to load;
r. “Outlet Draft limit”—the maximum draft, in ktons, that a vessel can carry to each load port considering the load port's outlet route draft limit (this value typically changes with each vessel, but a single value is utilized here since the vessels in this example are all either Aframax or Panamax class ships);
s. “Inlet Draft limit”—the maximum draft, in ktons, that a vessel can carry to each load port considering the load port's inlet route draft limit (again, this value typically changes with each vessel, but a single value is utilized here since the vessels in this example are all either Aframax or Panamax class ships);
t. “Revisit limit”—the maximum times any vessel can visit each load port on a single voyage; and
u. “Days For Next Visit (adjacency)—the minimum number of days that must elapse between consecutive vessel visits to each load port is input for company (XOM) load ports only.

The Port worksheet includes a table for user-company discharge port properties and a table for 3rd party discharge port properties. For each, the user inputs the following information:
v. “Discharge Port”—the name of each discharge port;
w. “Min Flow”—the minimum amount, in ktons, that each discharge port will permit a vessel to discharge;
x. “Max Flow”—the maximum amount, in ktons, that each discharge port will permit a vessel to discharge;
y. “Panamax Inlet Draft Limit”—the maximum weight of cargo, in ktons, that a Panamax can carry to each discharge port considering the discharge port's inlet route draft limits;
z. “Aframax Inlet Draft Limit”—the maximum weight of cargo, in ktons, that a Aframax can carry to each discharge port considering the discharge port's inlet route draft limits;
aa. “Revisit limit”—the maximum times a single vessel can visit each discharge port on a single voyage; and
bb. “Days For Next Visit (adjacency)—the minimum number of days that must elapse between consecutive vessel visits to each discharge port is input for company (XOM) discharge ports only.

The Port worksheet includes a table for the properties of spot sales ports (by ship). In this table, for the spot sale port (USSPOT_Sale), the user enters the following information:
cc. “Spot Sale (by ship)”—the name of the anticipated spot sale port;
dd. “Min Flow”—the minimum amount, in ktons, that the spot sale port will permit a vessel to discharge;
ee. “Max Flow”—the maximum amount, in ktons, that the spot sale port will permit a vessel to discharge;
ff. “Panamax Inlet Draft Limit”—the maximum weight of cargo, in ktons, that a Panamax can carry to the spot sale port considering the spot sale port's inlet route draft limit;
gg. “Aframax Inlet Draft Limit”—the maximum weight of cargo, in ktons, that a Aframax can carry to the spot sale port considering the spot sale port's inlet route draft limit; and
hh. “Discharge Revisit limit”—the maximum times a single vessel can visit the spot sale port on a single voyage.

The Product-Spec_Def contains properties used to assign a monetary value to the bulk product being transported (e.g., VGO for FCC units), the direction in which changes in such properties affect the monetary value and typical property values for different grades of the bulk product. This worksheet has two tables.

The first table identifies the properties that can affect the monetary valuation for the bulk product. In this case, the properties are as follows: sulfur content; analine content; Conradson carbon residue (CCR) content; nitrogen (N2) content; sodium (Na) content; nickel (Ni) content; copper (Cu) content; iron (Fe) content; vanadium (Va) content; and 50% temperature (i.e., the temperature at which half of the product evaporates). For each identified property, the units of measurement are specified. In addition, for each property, the following data is provided:
a. “Reverse”—whether higher (Y) values or lower (N) values of the property raise the bulk product value; and
b. “Value Base Unit”—the degree of property change for which the monetary adjustment factor (discussed later in the Product-Demand worksheet) is based.

The second table sets forth the typical property values for different grades of VGO. The different grades are low sulfur VGO, medium sulfur VGO and high sulfur VGO. The table lists the minimum and maximum sulfur content for each grade as well as the typical values for each property set forth in the first table measured in the same units.

The Product-Supply worksheet identifies the supply streams to be considered by the modeling tool, properties regarding the same and the monetary valuation of the same. This worksheet has two tables.

The first table identifies the supply streams and some basic information pertaining to the same. The following data is provided in this table for each supply stream:
a. “Name”—the name of the supply stream;
b. “On/Off”—a “1” is entered if the supply stream should be considered and a “0” is entered if the supply stream should not be considered;
c. “Port”—the load port where each supply stream is produced is indicated (some load ports produce multiple supply streams); and
d. “Barrels/Ton Calculated”—the barrels per ton for each supply stream is either automatically retrieved or automatically calculated from user inputs in subsequent columns entitled “Barrels/Ton,” “API” and/or “density.”

The second table identifies, for each VGO supply stream to be considered, the property values for each property listed in the Product-Spec_Def worksheet measured in the same units. Accordingly, for each supply stream to be considered (i.e., for each supply stream marked as “1” in the “On/Off” column of the Supply table), values for the following properties are set forth: sulfur content; analine content; Conradson carbon residue (CCR) content; nitrogen (N2) content; sodium (Na) content; nickel (Ni) content; copper (Cu) content; iron (Fe) content; vanadium (Va) content; and 50% temperature. In addition, for each supply stream, a stream “Value” is provided, which is the monetary assessment, in U.S. $/B, of the supply stream value in the applicable spot market of the supply port.

The Product-Demand worksheet identifies the demand streams to be considered by the modeling tool, property range requirements for the same, the monetary valuation of a typical stream of the required grade that meets the range requirements and property specific monetary adjustment factors to determine the monetary valuation of actual streams delivered to meet the range requirements. This worksheet has five tables.

The first table identifies the demand streams requiring product delivery and some basic information pertaining to the same. The following data is provided in this table for each demand stream:
e. “Name”—the name of each demand stream;
f. “On/Off”—a “1” is entered if the demand stream requirements should be considered and a “0” is entered if the demand stream requirements should not be considered;
g. “Port”—the discharge port where each demand stream is consumed is indicated (some discharge ports consume multiple streams);
h. “Feed Type”—the type of unit (e.g., FCC unit) that each demand stream feeds; and
i. “Barrels/Ton Calculated”—the barrels per ton for each demand stream is either automatically retrieved or automatically calculated from user inputs in subsequent columns entitled “Barrels/Ton,” “API” and/or “density” (this information is an estimate since actual values will vary depending on the properties of the actual streams delivered to meet demand stream consumptions).

The second table provides a base monetary valuation, in U.S. $/B, for a typical stream meeting the property range requirements of the demand port stream. The monetary valuation is a value assessment of the typical stream on the local spot market applicable to the demand port. For this calculation, the properties of a typical stream are taken from the Product-Spec_Def worksheet. In other words, if the demand stream is an HSVGO stream, then the typical stream used in this base value calculation will correspond to the typical HSVGO stream set forth in the Product-Spec_Def worksheet.

The third and fourth tables provide minimum and maximum property requirements for additional inventory delivered to meet the demand stream consumption. The properties listed are the same properties set forth in the Product-Spec_Def worksheet measured in the same units. Accordingly, for each demand stream to be considered (i.e., for each demand stream marked as “1” in the “On/Off” column of the Demand table), minimum and maximum values for the following properties are provided: sulfur content; analine content; Conradson carbon residue (CCR) content; nitrogen (N2) content; sodium (Na) content; nickel (Ni) content; copper (Cu) content; iron (Fe) content; vanadium (Va) content; and 50% temperature. It should be noted that one of the minimum and maximum values will be a soft limit and the other will be a hard limit, depending on whether the monetary valuation rises or false with increasing values for the property. A soft limit for a demand stream property means that the refinery will accept delivered product outside the property limit to meet demand stream consumption, but the refinery will not pay any additional value for exceeding the limit. A hard limit for a demand stream property means that the refinery will not accept delivered product outside the property limit to meet demand stream consumption. Whether a limit for a property is hard or soft can be determined from the “Reverse” field in the Product-Spec_Def worksheet. If the monetary valuation of the demanded product (VGO) rises with increasing property values (e.g., analine content), then the upper limit is the soft limit and the lower limit is the hard limit. If the monetary valuation of the product lowers with increasing property values (e.g., sulfur content) then the lower limit is the soft limit and the upper limit is the hard limit. Because the refinery will pay no additional monetary value for exceeding a soft limit, if a product is delivered with one or more properties outside a soft limit, then the product properties that are outside the soft limit will be assumed by the modeling program to equal, rather than exceed, the soft limit for the calculation of value adjustment.

The fifth table provides monetary adjustment factors that are both demand stream specific and property specific. More particularly, a monetary adjustment factor is provided for each demand stream for each of the properties listed in the Product-Spec_Def worksheet, namely: sulfur content; analine content; Conradson carbon residue (CCR) content; nitrogen (N2) content; sodium (Na) content; nickel (Ni) content; copper (Cu) content; iron (Fe) content; vanadium (Va) content; and 50% temperature. Monetary adjustment factors are used in calculating the monetary value of the streams actually delivered to meet demand stream consumption and minimum and maximum property requirements. The reason monetary adjustment factors are needed is that it is highly unlikely that a delivered stream will conform exactly to the typical stream for which the base value is derived. In fact, the actual value for the delivered streams may vary greatly based on the actual properties of the delivered streams. The degree of this variance, per value base unit set forth in the Product-Spec_Def worksheet, is reflected in the monetary adjustment factors.

For example, suppose a property of a delivered stream is within the maximum and minimum values required for the demand stream, but is nonetheless different than a typical stream upon which the base value in the Base Value table has been calculated. If so, then an adjustment to the base value needs to be calculated in the following manner:

A={[(P_{T}−P_{A})/VBU]×MAF}

where A is the adjustment in U.S. $/B, P_{T} is the typical property value taken from the Product-Spec_Def worksheet, P_{A} is the actual property value of the discharged product, VBU is the value base unit for the property taken from the Product-Spec_Def worksheet and MAF is the monetary adjustment fact in U.S. $/B. This is done each time there is a property variance. Each adjustment factor is then added or subtracted from the base value, depending on whether the change in property value was monetarily beneficial or detrimental as indicated in the “Reverse” field of the Product-Spec_Def worksheet, to generate the actual monetary valuation of the delivered product.

The Production worksheet details projected production/inventory for each supply stream during the production horizon assuming no inventory is moved. This worksheet has three tables.

The first table details the daily projected inventory (Inv) and minimum (Min) and maximum (Max) inventory constraints for each user-company supply stream during the production time horizon. The inventory minimum, in ktons, is the minimum amount of the supply stream (typically zero) that the supply port requires in storage on any given day. Conversely, the inventory maximum, in ktons, is the maximum amount of the supply stream that the supply port permits on any given day. As indicated, as production continues but inventory is not moved, the inventory maximum is eventually reached and, thereafter, surpassed more and more each day. This time table of inventory build-up and inventory capacity is considered for voyage load schedules.

The second table identifies the supply streams, if any, that can be loaded at third party ports to augment company production, the start and end dates that mark the time window when such pick-ups can occur, and the amounts, in ktons, that can be loaded. Generally, this data reflects contract terms. The third table identifies the supply streams that may be purchased on the spot market to augment production. The daily projected availability of such streams, in ktons, is provided (which generally remains steady).

The Consumption worksheet details projected consumption/inventory for each demand stream during the consumption window assuming no additional inventory is delivered. This worksheet has three tables.

The first table details the daily projected inventory (Inv) and minimum (Min) and maximum (Max) inventory constraints for each user-company demand stream during the consumption time period under consideration. The inventory minimum, in ktons, is the minimum amount of product for the demand stream that the demand port requires on any given day. Conversely, the inventory maximum, in ktons, is the maximum amount of product for the demand stream that the demand port will permit on any given day (typically this equals the maximum storage capacity). As inventory depletes and is not replenished, the demand stream needs will eventually cease to be met and, thereafter, projected inventory has negative values. This time table of inventory depletion and inventory capacity is considered for voyage delivery schedules.

The second table entitled identifies the demand streams, if any, that can be discharged to third party ports to deplete overage, the start and end dates that mark the time window when such deliveries should can occur, and the amounts, in ktons, that can be discharged. Generally, this data reflects contract terms. The third table identifies the demand streams that may be sold on the spot market to deplete overage. The daily projected availability of such streams, in ktons, is provided (which generally remains steady).

The Legs worksheet allows the user to forbid voyages that have legs between specific load ports, between specific discharge ports, and between specific load and discharge ports. This worksheet has three tables.

The first table provides a matrix of load port origins (“from”) and load port destinations (“to”). By entering a one (1) into a cell representing any origin/destination combination of two load ports, any voyage comprising a leg from the indicated origin load port to the indicated destination load port is forbidden. The second table provides a matrix of load port origins (“from”) and discharge port destinations (“to”). By entering a one (1) into any cell representing any origin/destination combination of load port and destination port, any voyage comprising a leg from the indicated origin load port to the indicated destination discharge port is forbidden. The third table provides a matrix of discharge port origins (“from”) and discharge port destinations (“to”). By entering a one (1) into a cell representing any origin/destination combination of two discharge ports, any voyage comprising a leg from the indicated origin discharge load port to the indicated destination discharge port is forbidden.

The Ship worksheet identifies the spot vessel charters that have been chartered or are of interest (this particular example only employs spot vessels), as well as the physical and cost parameters for the same and relevant port restrictions for the same. This worksheet has three tables.

The first table contains the information set forth below for each vessel.
a. “Name”—the name of the vessel;
b. “Vessel Use”—whether the vessel is already “chartered” (and, therefore, must be used) or whether the spot vessel would be a “new” charter.
c. “Vessel Type”—whether the vessel is an “Aframax” or “Paramax” class vessel.
d. “Max Capacity”—the maximum vessel capacity of the vessel in ktons.
e. “Worldscale”—the vessel specific rate, relative to Worldscale100, that the spot vessel charges. Worldscale is a periodically updated average rate (in U.S. $/kton) for carrying cargo on various routes. This average value is designated as Worldscale100 (WS100). Depending on market conditions, vessel size, etc., a spot vessel may charge more or less than WS100 for performing voyages. This variation, expressed as a percentage of WS100, typically ranges from 40% (0.40) to 200% (2.00).
f. “Base Volume”—the part cargo minimum, in ktons, for which the vessel will charge even if less volume is loaded;
g. “Overage”—the percentage of the basic transportation rate the spot vessel charges for each additional ton of cargo transported over the base volume;
h. “Demurrage”—the idle cost of the vessel in U.S. k$/day;
i. “Max Demurrage Days (Actual)”—the maximum demurrage days allowed;
j. “Start Date (chartered date) for vessel”—the first date of the vessel's contract;
k. “Last Window Date”—the last day loading on the vessel should finish;
l. “Actual Arrival Date for Chartered Vessels”—the first day a previously chartered vessel is actually available (which may be earlier than the start date from which demurrage is calculated);
m. “Penalty/(Incentive) to use Vessel”—penalties or incentives to use a specific vessel; and
n. “Min % Basis Vol”—the minimum percentage of the base volume that must be loaded.

The second table provides one matrix of vessel names and load ports and another matrix of vessel names and discharge ports. By entering a one (1) in a cell representing any combination of a given vessel and a port, any voyage wherein the given vessel travels to the given port is forbidden. The third table provides a matrix of vessel names and supply streams. It may be that, at the start of the planning period, some of the vessels to be considered in the loading and delivery schedules are already partially or fully loaded. If so, the amount, in ktons, of each supply stream already loaded on the vessel is entered in the corresponding to the vessel and the loaded streams.

The Time worksheet records the average days it takes a vessel to transit each potential leg in a voyage. This worksheet has three tables. The first table provides a matrix of origin load ports (“from”) and destination load ports (“to”). The average travel time, in days, for a vessel to move from each origin load port to each destination load port is set forth in the cell representing the origin load port/destination load port combination.

The second table provides a matrix of origin load ports (“from”) and destination discharge ports (“to”). The average travel time, in days, for a vessel to move from each origin load port to each destination discharge port is set forth in the cell representing the origin load port/destination discharge port combination. The third table provides a matrix of discharge load ports (“from”) and destination discharge ports (“to”). The average travel time, in days, for a vessel to move from each origin discharge port to each destination discharge port is set forth in the cell representing the origin discharge port/destination discharge port combination.

The Cost worksheet records the trade route specific Worldscale100 rate (in U.S. $/ton) for moving cargo on each potential leg in a voyage. The trade route specific Worldscale100 rate, when multiplied by (a) the base volume (provided in the Ship worksheet) and (b) the relative percentage of the Worldscale100 rate a vessel charges (provided in the Ship worksheet), equals the flat rate the vessel will charge to perform the voyage leg. Similarly, this rate, when multiplied by (a) the overage rate for a vessel (provided in the Ship worksheet), (b) the overage amount, in ktons, and (c) the relative percentage of the Worldscale100 rate a vessel charges (provided in the Ship worksheet), equals the overage cost for a voyage leg. Even though a specific leg does not have any overage, if a voyage has any overage leg, overage cost is charged to all the legs in the voyage based on the maximum amount of overage in that voyage. The total cost to perform any given voyage is then the sum of the flat rate and overage costs for each leg of the voyage using the vessel. This worksheet has three tables.

The first table provides a matrix of origin load ports (“from”) and destination load ports (“to”). The average cost, in U.S. k$/kton, for a vessel to carry cargo from any origin load port to any destination load port is set forth in the cell representing the combination of the origin load port and the destination load port. The second table provides a matrix of origin load ports (“from”) and destination discharge ports (“to”). The average cost, in U.S. k$/kton, for a vessel to carry cargo from any origin load port to any destination discharge port is set forth in the cell representing the combination of the origin load port and the destination discharge port. The third table provides a matrix of origin discharge ports (“from”) and destination discharge ports (“to”). The average cost, in U.S. k$/kton, for a vessel to carry cargo from any origin discharge port to any destination discharge port is set forth in the cell representing the combination of the origin discharge port and the destination discharge port.

The BlackOut worksheet records any days within the relevant production or consumption horizons in which a load port will not be available for cargo loading or a discharge port will not be available for cargo discharge, respectively. This worksheet has two tables.

The first table sets forth the first and last day in the production window and provides a matrix of each day in the production window and each load port. If, for any load port, there will be one or more days when cargo cannot be loaded at the port, then a “Yes” is entered into the cells corresponding to those days at the load port. Otherwise, the default for all the cells is “No”—meaning that cargo can be loaded at the given port on the given day. The second table sets forth the first and last day in the consumption window and provides a matrix of each day in the consumption window and each discharge port. If, for any discharge port, there will be one or more days when cargo cannot be discharged at the port, then a “Yes” is entered in the cell corresponding those days at the discharge port. Otherwise, the default for all the cells is “No”—meaning that cargo can be discharged at the given port on the given day.

The Tank_Details worksheet provides details regarding the blending tanks:
a) Basic tank inputs: port location of tank, initial inventory in tank, density of initial inventory in tank, cost of initial inventory.
b) Allowed stream transfers to specify which streams are allowed into/out of tank.
c) Transfer times for time lags between tank site and other ports.
d) Daily transfer limits for maximum amount transferable between tank and demand stream per day by a vehicle or pipeline. Barge capacity entered for barge transfers and pipeline capacity entered for pipeline transfers.
e) Minimum and maximum tank inventory limits per day.

The Tank_Details worksheet may also includes the following information relating to leased tanks:
a) Whether tank use is mandatory.
b) Start and end dates of lease.
c) Amounts in/out of tank to date—used to account for tank usage to date while calculating variable lease costs.
d) Maximum number of tank turns expected in a calendar month. A tank turn is one cycle of a given amount of material, which is usually the tank capacity, moved into and out of a tank.
e) Information relating to the variable lease costs incurred for tank usage. For example, this may include the maximum quantity of material that can be moved through the tank without incurring variable lease costs.

The Tank_Specs worksheet provides information relating to the blending tank contents:
a) Specifications of tank contents at start of time period.
b) Mapping to valuation streams: Specifies which demand stream corresponds to each tank's spot market valuation streams.
c) Daily average minimum and maximum property limits per specification that can be stored in the tank.

At the end of the planning horizon, blending tank content valuation may be performed by the use of virtual demand streams where the leftover tank material is mapped (“discharged”) to these virtual demand streams. The Product-Demand worksheet is used to determine the product and its value.

### Meteoroid—Interface

The METEOROID model is written in the AIMMS modeling language and employs an AIMMS graphical user interface. This user interface enables the user to review and alter the data, vary options for the problem to be solved, solve the model, and review the solution results. For example, the interface may display data tables showing the current bounds on the minimum and maximum number of vessels, the maximum demurrage days, time windows for load ports, penalties for using a vessel, maximum transportation cost/ton, minimum tons transported, slack penalties, days between consecutive visits to ports, minimum percent of base volume, and load only demurrage. There may also be a “YES” or “NO” entry about whether the aforementioned options should or should not be recognized. The user can change any of this data directly.

The interface can also present several options for how the problem is to be solved. The interface can display the solution or decisions derived from the solution in any of various ways. One way is to provide a solution summary that sets forth the total value (in U.S. k$) of loaded and discharged product, shipping costs for the same, holding costs for the same, any assigned penalties to the solution obtained if it is infeasible, the total amount (in ktons) of product transported, and the identity dates and amounts of each stream that each ship or barge loaded and discharged.

In addition, the interface can allow the user to view more detailed information. For example, the interface may present a list of each supply stream and the total amounts (in ktons and kB) to be loaded. In addition, for each supply stream, the user can view the vessels that load products from the supply stream, the corresponding load dates, the load amounts (in ktons and kB) and monetary value (in U.S. k$) of the load product, and the daily inventory level of the supply stream over the production period.

In another example, the interface may present a list of each demand stream for which product is to be delivered and the total amounts (in ktons and kB) to be delivered. In addition, for each demand stream, the user can view the vessels that deliver products for the demand stream and the corresponding discharge date, the discharge amounts (in ktons and kB) and monetary value (in U.S. k$) for the deliveries, and the inventory level of the demand stream over the consumption period.

In another example, the interface may present details, by vessel, of each delivery made to each demand port, including the vessel name, the demand stream name for which delivery was intended, the date of delivery, the delivery amounts (in ktons and kB), the density (B/ton) of the delivery, the monetary value (U.S. k$/B and U.S. k$)) of the delivery and the base value of a typical stream (in U.S. k$/B) that would meet the demand stream's property range requirements. For a particular vessel's delivery for a particular demand stream, the interface may present the blending recipe for the delivery product (if applicable). For each cargo that contributed to the blended product, the amount (in ktons and kB), monetary value at the time of load (in U.S. $k/B and U.S. $k) and properties are provided. In addition, the amount (in ktons and kB), discharge value (in U.S. $k/B and U.S. $k) and properties of the blended product to be delivered are provided. Finally, value adjustments made to value of the product to be discharged, compared to the base value of a typical product that would meet the demand stream's property range requirements, are detailed, in total and by property.

In another example, the interface may present a listing of the numbered days in the planning period for loading, discharging, and other activities of each vessel. The interface may also show a listing of the numbered day in the planning period for loading, discharging, and other activities of each port. The interface may also show a listing of the vessel assignments, voyages, loading and discharging amounts, associated flat rate, overage and demurrage costs, etc., both as a whole and by individual vessel. The interface may also show details of the identity, amount, and monetary value of spot market purchases in the solution. The interface may also show details of the daily inventory at each loading port, discharge port and on each vessel, and the associated individual and total costs for the same.

### Meteoroid—Mathematical Model

The mathematical model of METEOROID is based on a ship inventory routing problem in which each loading port may have multiple supply streams. Since each supply stream produces a different product, the problem is a multi-product problem. It is not a conventional multi-product distribution problem because each supply stream has its own product specifications and each demand stream has its own acceptable specifications. Further, completely new products can be produced by blending several products, which can be performed on-shore, or onboard the vehicle during loading, discharge or transit. The value of a discharged product stream is determined based on the specifications of the discharged product. An example includes blending of lower value product (i.e., HSVGO), which is not acceptable to some particular demand streams, with a high quality product (i.e., LSVGO) to create a new product stream that is acceptable to the demand stream.

The objective of the mathematical optimization problem is to maximize profit, which can be defined as the sum of the values of discharged products for demand streams minus the values of the loaded products at the supply streams minus all of the transportation related costs. Due to the flexibilities in the compartments of ships, a ship may load several products, blend them into several new products, and discharge them at several demand streams based on the economics and consumption rates at the demand streams.

In general, net profit margin is revenue minus expenses. In the context of the present invention, net profit margin includes one or more factors relating to the monetary value of the bulk products and one or more factors relating to cost(s) associated with the bulk products. In some cases, net profit margin can include one or more of the following factors: the sum of the monetary values of the bulk products discharged to the demand streams (directly from the vehicles, from the blending tanks, or both), the sum of the monetary values of the bulk products loaded from the supply streams, the costs related to the transportation of the bulk products between the supply locations and the demand locations, or the costs related to the use of the blending tanks

In certain embodiments, the objective function of the model further comprises the sum of the monetary values of the products discharged from the blending tanks to the demand streams. The objective function may also include the sum of the costs associated with the use of the blending tanks. For example, such costs may include tank leasing costs, tank maintenance costs, pumping costs, or costs for discharging the bulk products to the demand streams (e.g., by barge or pipeline). In some cases, the objective function also includes value adjustments based on the specification requirements of the demand streams. In some cases, the objective function includes the monetary value of the inventory remaining in the blending tank at the end of the period (e.g., end of the day) and/or the inventory in the blending tank(s) at the beginning of the period (e.g., beginning of the day). The formal definition of the mathematical model follows.

Multiple products are distributed from a set J^{L} of load ports to a set J^{D} of discharge ports over a planning horizon T. The model presented in this report is a discrete time model and time t belongs to the set {1, 2, . . . , T}. Although the time unit used in practice is one day, a different unit of time could easily be substituted and applied as necessary. A set J of all ports is the union of J^{L} and J^{D}. The set J^{L}^{_{O}}⊂J^{L} represents the set of load ports owned and/or operated by the user-company. The set J^{L}^{_{PR}}⊂J^{L} represents the set of spot purchase load ports from which material from the spot purchase market can be bought. The set J^{L}^{₃}⊂J^{L} represents the set of load ports operated by third parties. The set J^{D}^{_{O}}⊂J^{D} represents the set of discharge ports owned and/or operated by the user-company. The set J^{D}^{_{SL}}⊂J^{D} represents the set of discharge ports for spot sale markets where material can be sold to the spot purchase markets via spot ship or barge, and the set J^{D}^{₃}⊂J^{D} represents the set of discharge ports operated by third parties. The set J^{DL}⊂J is the set of ports with draft limits. The number of loads or discharges by a ship at port j may be limited such that each ship may not load or discharge at some port j more than Uⱼ times.

Each load port jεJ^{L} has a set SSⱼ of supply streams. Each discharge port jεJ^{D} has a set DSⱼ of demand streams and may have a set of blend tank streams BSⱼ (thus, for some discharge ports jεJ^{D}, the set of blend tank streams BSⱼ may be empty). The set SS and the set DS represent the set of all supply streams and the set of all demand streams, respectively. The set BS represents the set of all blend tank streams. Furthermore, the set BS_{ds}^{IN,BS}⊂BS represents the set of blend tank streams that can discharge into demand stream dsεDSⱼ, jεJ^{D}, while the set DS_{bs}^{OUT,BS}⊂DS represents the set of demand streams that blend tank stream bs can discharge into. Similarly, the set BS_{bs}^{IN,BS}⊂BS represents the set of blank tank streams bs′≠bsεBSⱼ, jεJ^{D}^{_{O}} that can discharge into blend tank stream bsεBSⱼ, jεJ^{D}^{_{O}}, while the set BS_{bs}^{OUT,BS}⊂BS represents the set of blend tank streams bs′≠bsεBSⱼ, jεJ^{D}^{_{O}} that blend tank stream bsεBSⱼ, jεJ^{D}^{_{O}} can discharge into. Finally, the sets SS_{ds}^{IN,DS}, dsεDSⱼ, jεJ^{D} and SS_{bs}^{IN,BS}, bsεBSⱼ, jεJ^{D}^{_{O}} represent the supply streams that can discharge into demand stream dsεDS and into blend tank stream bsεBS, respectively.

Let Q represent a set of all tracked properties, and let its subsets Q̅ or Q represent the different directions for value adjustments on products based on property. Each qεQ may only belong in either Q̅ or Q, but not in both. If qε Q̅, then value increases with higher specifications of property q. If qεQ, then value increases with lower specifications of property q. Each supply stream ssεSSⱼ, jεJ^{L}^{_{O}} has an initial inventory I_{ss,0}^{SS} on the beginning day and a value VLₛₛ per unit at its supply port, and produces P_{ss,t} amount of product from time t−1 to time t. The inventory level of supply stream ssεSS has to be larger than or equal to I_{ss,t}^{MIN,SS} and less than or equal to I_{ss,t}^{MAX,SS} at time t. The product from supply stream ssεSSⱼ, jεJ^{L} has SS_{ss,q}^{SS} specification for property qεQ. Each demand stream dsεDSⱼ, jεJ^{D}^{_{O}} also has an initial inventory I_{ds,0}^{DS} on the beginning day, and consumes D_{ds,t} amount of product from time t−1 to time t. The inventory level of demand stream dsεDS has to be larger than or equal to I_{ds,t}^{MIN,DS} and less than or equal to I_{ds,t}^{MAX,DS} at time t. Furthermore, each blend tank stream bsεBS has an initial inventory I_{bs,0}^{BS} on the beginning day, and the inventory level of blend tank stream bsεBS has to be larger than or equal to I_{bs,t}^{MIN,BS} and less than or equal to I_{bs,t}^{MAX,BS} at time t. When a ship stops at load port jεJ^{L}^{_{O}}, it can load from any ssεSSⱼ, but the total amount of load has to be greater than or equal to Fⱼ^{MIN} and less than or equal to Fⱼ^{MAX}. When a ship stops at discharge port jεJ^{D}^{_{O}}, it can discharge at any demand stream dsεDSⱼ and/or at any blend tank stream bsεBSⱼ, but the total amount of discharge has to be greater than or equal to Fⱼ^{MIN} and less than or equal to Fⱼ^{MAX}.

The calculation of the value of discharged product for a demand stream is somewhat complex. Each demand stream ds has its standard specification STD_{ds,q}^{DS} for each property qεQ. If the level of property q of discharged product is different from STD_{ds,q}^{DS}, then its value needs to be adjusted. The following notations are necessary for the presentation of the model. The level of qεQ of discharged product for demand stream dsεDS needs to be greater than or equal to LBH_{ds,q} and less than or equal to UBH_{ds,q}. These are called hard bounds. If the level of qεQ of discharged product for demand stream dsεDS is less than LBS_{ds,q}^{DS} or the level of qε Q̅ of discharged product for demand stream dsεDS is greater than UBS_{ds,q}^{DS}, then the value adjustment is calculated based on LBS_{ds,q}^{DS} or UBS_{ds,q}^{DS}, respectively. These are called soft bounds. Without loss of generality, it is assumed that LBH_{ds,q}≦LBS_{ds,q}^{DS}≦UBH_{ds,q} for each qεQ and LBH_{ds,q}≦UBS_{ds,q}^{DS}≦UBH_{ds,q} for each qε Q̅. In the METEOROID implementation, when qε Q̅, we set UBH_{ds,q}=∞. When qεQ, we set LBH_{ds,q}=0. These settings are based on user requests. The base value per unit of discharged product for demand stream ds is denoted by VLB_{ds}^{DS}. For every value base unit VBU_{q}, difference between the specification of q of discharged product and the standard specification STD_{ds,s}^{DS}, the value per unit of discharged product for demand stream ds increases or decrease from VLB_{ds}^{DS} by VS_{ds,q}^{DS} value versus standard, depending on whether qε Q̅ or qεQ. As mentioned earlier, if the specification of q of discharged product for demand stream ds is less than LBS_{ds,q}^{DS} with qεQ or greater than UBS_{ds,q}^{DS} with qε Q̅, then LBS_{ds,q}^{DS}−STD_{ds,q}^{DS} or UBS_{ds,q}^{DS}−STD_{ds,q}^{DS} is used for the calculation of value adjustment, respectively.

The set V is the set of ships available for the transportation. A ship may stop at multiple load ports, load from multiple supply streams, stop at multiple discharge ports, and discharge to multiple demand and blend tank streams. If a ship stops at a port with multiple streams, it can load from or discharge to multiple streams at the same time. Each ship vεV has an initial inventory I_{v,ss,0}^{V} of supply stream ss on the beginning day. Each ship v has a maximum amount of product Iᵥ^{MAX,V} it may carry. Travel times between ports j and j′ are denoted by T_{jj′}, and it is assumed that T_{jj′} is a multiple of the discrete time unit (one day in this case). A ship vεV may belong to a set V^{CHART} of previously chartered ships. Each ship vεV^{CHART} becomes available at time Tᵥ^{CHART} and must be used in a model solution. Each non-chartered ship vεV†V^{CHART} may or may not be used. For each vεV, jεJ^{DL}, and tε{1, 2, . . . , T} the inlet draft limit DLᵥⱼₜ^{IN} and outlet draft limit DLᵥⱼₜ^{OUT} need to be satisfied. For each ship vεV, Bᵥ, WSᵥ, DRᵥ, and OVRᵥ represent basis amount of product (PC tons), world scale multiplier, demurrage rate and overage rate respectively. The flat rate for traveling from port jεJ to port j′εJ is C_{jj′}. If ship v travels from port j to port j′, the flat cost for this leg is BᵥWSᵥC_{jj′}. The demurrage cost for ship v is calculated by DRᵥ multiplied by the number of demurrage days in ship v's voyage. Overage refers to the product tons over the basis amount Bᵥ. If any leg of ship v's voyage incurs overage, the overage rate OVRᵥWSᵥC_{jj′} applies to all the legs of ship v's voyage based on the largest amount of overage of that voyage.

The objective is to maximize profit while satisfying all the requirements. The profit is defined by values of discharged product at demand streams in addition to the value of the final inventory in all blend tanks minus values of loaded product at supply streams minus the value of the initial inventory in all blend tanks minus total transportation costs over the planning horizon T.

### Space-Time Network Formulation

The time-space network formulation can be viewed as an integer multi-commodity flow formulation in which a ship is a commodity and nodes represent a possible visit to a port at a particular time. The network has a set of nodes and a set of arcs. The node set is shared by all ships, and each ship has its own arc set. The set of nodes N consists of one origin node (0,0), one sink node (0,T+1), and a set of regular nodes N^{R}={(j,t):jεJ, tε{1, 2, . . . , T}}. Each ship v has its own arc set Aᵥ. Then set of arcs A=∪_{vεV}Aᵥ.

Each set of arcs Aᵥ consists of five types of arcs. A travel arc (v,(j,t),(j′,t+T_{jj′})) such that vεV, (j,t)εN^{R}, (j′,t+T_{jj′})εN^{R}, and j≠j′ represents the possibility of ship v to travel from port j to port j′, leaving at time t and arriving at time t+T_{jj′}. Let Aᵥ^{T} denote the set of all travel arcs for ship v. Then A^{T}=∪_{vεV}Aᵥ^{T} represents the set of all travel arcs. A demurrage arc (v,(j,t),(j,t+1)) with vεV, (j,t)εN^{R} and (j,t+1)εN^{R} represents the possibility of ship v to wait at port j from time t to time t+1. Let Aᵥ^{D} denote the set of all demurrage arcs for ship v. Then A^{D}=∪_{vεV}Aᵥ^{D} represents the set of all demurrage arcs. An arc (v,(0,0),(j,t)) with vεV and (j,t)εN^{R} represents when and where ship v starts its voyage. An arc (v,(j,t),(0,T+1)) with vεV and (j,t)εN^{R} represents when and where ship v ends its voyage. An arc (v,(0,0),(0,T+1)) represents the possibility of ship v not being used. Let Cₐ represent the cost of using arc a. The cost of using travel arc aεAᵥ^{T} which goes from node (j,t) to node (j′,t+T_{jj′}) is BᵥWSᵥC_{jj′}. The cost of using demurrage arc aεAᵥ^{D} is DRᵥ. The cost of the remaining arcs is set to zero. Let δ⁺(n) denote the set of arcs that have node n as their tail node. The set of arcs that have node n as their head node is denoted by δ⁻(n).

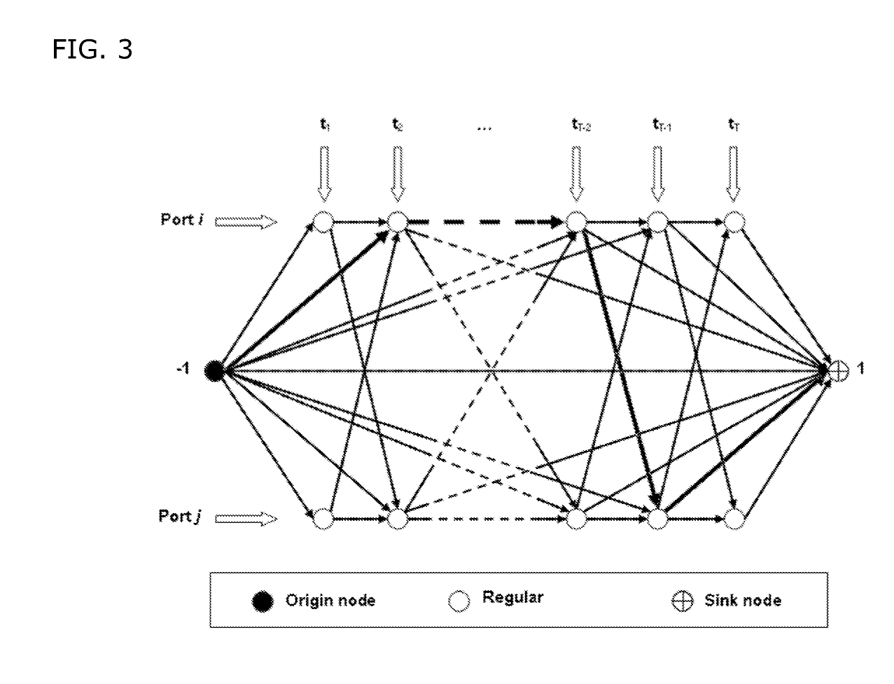

FIG. 3 shows an example of the network structure described above. In this example, a ship enters the system at time t₂ by arriving at port i. After spending several days of demurrage, it visits port j at time t_{T-1} and leaves the system.

The continuous decision variable f_{n,ss,v}^{SS,V} with n=(j,t)εN^{R}, jεJ^{L}^{_{O}}, and ssεSSⱼ represents the loading amount of product from supply stream ss to ship v at time t. The continuous decision variable f_{n,v,ss,ds}^{V,DS} with n=(j,t)εN^{R}, jεJ^{D}, dsεDSⱼ, and ssεSS represents the discharge amount of ss product for demand stream ds from ship v at time t. Similarly, the continuous variable f_{n,v,ss,bs}^{V,BS} with n=(j,t)εN^{R}, jεJ^{D}^{_{O}}, bsεBSⱼ, and ssεSS represents the discharge amount of ss product for blend tank stream bs from ship v at time t. The continuous decision variable f_{bs,ds,t}^{BS,DS} with bsεBS_{ds}^{IN,DS}, and dsεDSⱼ, jεJ^{D}, tε{1, 2, . . . , T} represents the discharge amount of bs product for demand stream ds at time t. The continuous decision variable f_{bs,bs,t}^{BS,BS} with bs′,bsεBSⱼ, bs′≠bs, jεJ^{D}^{_{O}}, tε{1, 2, . . . , T}, represents the discharge amount of bs′ product into blend tank stream bs at time t. The continuous variable fs_{ss,ds,t}^{SS,DS} with dsεDS, ssεSS_{j,ds}^{IN,DS}, jεJ^{L}^{_{PR}} and tε{1, 2, . . . , T} represents the amount of product bought from the spot purchase market and discharged (via barge) into demand stream ds. Similarly, the continuous variable fs_{ss,bs,t}^{SS,BS} with bsεBS, ssεSS_{j,bs}^{IN,BS}, jεJ^{L}^{_{PR}} and tε{1, 2, . . . , T} represents the amount of product bought from the spot purchase market and discharged (via barge) into blend tank stream bs. Note that any movement from some blend tank bs to some other blend tank bs′ or demand stream ds via barge incurs a transportation cost CST_{bs,j}^{BG}, expressed in units of cost per ton.

The continuous decision variable i_{v,ss,t}^{V} represents the inventory level of product from supply stream ss on ship v at the end of time t. The continuous decision variable i_{ss,t}^{SS} with ssεSS and tε{1, 2, . . . , T} denotes the inventory level of supply stream ss the end of time t. The continuous decision variable i_{ds,t}^{DS} with dsεDS and tε{1, 2, . . . , T} denotes the inventory level of demand stream ds the end of time t. Similarly, the continuous decision variable i_{bs,t}^{BS} with bsεBS and tε{1, 2, . . . , T} denotes the inventory level of blend tank stream bs the end of time t. Furthermore, because of the capacity to perform on-shore blending, the property specifications of the blended streams at every blend tank must be tracked on a daily basis. This is achieved by defining the continuous decision variable s_{bs,q,t}^{BS} with qεQ, bsεBS and tε{1, 2, . . . , T}. The continuous variable sav_{n,v,ds,q}^{V,DS} represents the specification adjusted value based on property qεQ of discharged product for demand stream dsεDS by ship vεV where n=(j,t)εN^{R} and dsεDSⱼ. The continuous variable sav_{bs,ds,q,t}^{BS,DS} represents the specification adjusted value based on property qεQ of discharged product for demand stream dsεDS by blend tank stream bsεmathcal BS_{ds}^{IN,DS} at time t, with tε{1, 2, . . . , T}. Similarly, the continuous variable sav_{bs,q,T}^{BS} represents the specification adjusted value based on property qεQ of blend tank inventory for blend tank stream bsεBS at time T. The continuous variable oᵥ for each ship vεV represents the largest amount of overage of ship v's voyage. Another continuous variable o_{a,v} for each travel arc aεAᵥ^{T} and vεathcalV is equal to oᵥ if arc a is used. Otherwise o_{a,v} takes zero. The variable o_{a,v} is used in the objective function for the calculation of overage costs.

The binary variable xₐ for each aεAᵥ, takes a value 1 if ship v uses arc a and takes the value 0 otherwise. The binary variable z_{n,v} for each ship vεV and each node n=(j,t)εN^{R} indicates whether or not ship v loads product(s) from port j if jεJ^{L}^{_{O}} and discharges product(s) to port j if jεJ^{D} at time t. The binary variable w_{n,bs}¹ with n=(j,t)εN^{R}, jεJ^{D}^{_{O}} and bsεBSⱼ takes a value of 1 if no outputs occur from blend tank bs at time t. The binary variable w_{n,bs}² with n=(j,t)εN^{R}, jεJ^{D}^{_{O}} and bsεBSⱼ takes a value of 1 if no inputs occur into blend tank bs at time t. The binary variable w_{n,bs}³ with n=(j,t)εN^{R}, jεJ^{D}^{_{O}} and bsεBSⱼ takes a value of 1 if no inputs and outputs occur from blend tank bs at time t. Note that binary variables w_{n,bs}¹, w_{n,bs}² and w_{n,bs}³ are mutually exclusive. Finally, binary variable y_{bs,ds,t} with dsεDS, bsεBS_{ds}^{IN,DS} and tε{1, 2, . . . , T} takes a value of 1 if blend tank stream bs discharges into demand stream ds at time t. In that case, the property specifications s_{bs,q,t} of product discharged from blend tank stream bs into demand stream ds at time t meet the allowable range of property specification of demand stream ds, namely [LBH_{ds,q},UBH_{ds,q}], and the amount f_{bs,ds,t}^{BS,DS} discharged at that time t must be between F_{bs,t}^{MIN,BS} and F_{bs,t}^{MAX,BS}.

The remainder of this section presents the time-space network-based formulation for METEOROID. We note that the following assumptions were made in the formulation of the mathematical programming model:
Inventories and property specifications are based on end of day values
Only one ship berth per (load, discharge, blend tank) port per day
Load and discharge times from vessels are included in T_{jj′}
Multiple inputs or multiple outputs are allowed to occur on the same day for blend tanks
Multiple inputs and multiple outputs are not allowed to occur on the same day for blend tanks
Spot to blend tank feeds and blend tank to blend tank transfers are allowed
All inputs to demand streams must be individually on specification
All inputs to demand streams are individually valuated

The first group of equations represents the flow conservation constraints.

$$\begin{matrix}{\sum }_{\{ a ∈ {A}_{v} : a ∈ {δ}^{-} ( n ) \}} {x}_{a} - {\sum }_{\{ a ∈ {A}_{v} : a ∈ {δ}^{+} ( n ) \}} {x}_{a} = 0 ∀ v ∈ V , ∀ n ∈ {N}^{R} , & ( 1 ) \\ {\sum }_{\{ a ∈ {A}_{v} : a ∈ {δ}^{+} ( ( 0 , 0 ) ) \}} {x}_{a} = 1 , ∀ v ∈ V , & ( 2 ) \\ {\sum }_{\{ a ∈ {A}_{v} : a ∈ {δ}^{-} ( ( 0 , T + 1 ) ) \}} {x}_{a} = 1 , ∀ v ∈ V . & ( 3 )\end{matrix}$$

The next set of constraints ensures inventory balance of supply streams at the load ports owned and/or operated by the user-company, as well as of demand streams at discharge ports.

$$\begin{matrix} {i}_{ss , t}^{SS} = {i}_{ss , t - 1}^{SS} + {P}_{ss , t} - {\sum }_{v ∈ V} {f}_{n , ss , v}^{SS , V} , ∀ n = ( j , t ) ∈ {N}^{R} , ∀ j ∈ {J}^{{L}_{O}} , \\ ∀ ss ∈ {SS}_{j} , & ( 4 ) \\ {i}_{ds , t}^{DS} = {i}_{ds , t - 1}^{DS} + {\sum }_{v ∈ V} {\sum }_{ss ∈ SS} {f}_{n , v , ss , ds}^{V , DS} + {\sum }_{ss ∈ {SS}_{{j}^{′} , ds}^{IN , DS} , {j}^{′} ∈ {J}^{{L}_{PR}}} {f}_{ss , ds , t}^{SS , DS} + {\sum }_{bs ∈ {BS}_{ds}^{IN , DS}} {f}_{bs , ds , t - {TT}_{bs , ds}^{BS , DS}}^{BS , DS} - {D}_{ds , t} , \\ ∀ n = ( j , t ) ∈ {N}^{R} , ∀ j ∈ {J}^{{D}_{o}} , ∀ ds ∈ {DS}_{j} . & ( 5 )\end{matrix}$$

The next set of constraints ensures inventory and property-specification balances of blend tank streams at discharge ports. We note that the property specifications s_{bs,q,t-1}^{BS} on the right-hand side of constraint (7) are indexed by t−1 instead of t in order to maintain consistency in tracking adjacent-day inventory and specifications.

$$\begin{matrix}{i}_{bs , t}^{BS} = {i}_{bs , t - 1}^{BS} + {\sum }_{v ∈ V} {\sum }_{ss ∈ SS} {f}_{n , v , ss , bs}^{V , BS} + {\sum }_{{bs}^{′} \neq bs ∈ {BS}_{bs}^{IN , BS}} {f}_{{bs}^{′} , bs , t - {TT}_{{bs}^{′} , bs}^{BS , BS}}^{BS , BS} + {\sum }_{ss ∈ {SS}_{{j}^{′} , bs}^{IN , BS} , {j}^{′} ∈ {J}^{{L}_{PR}}} {f}_{ss , bs , t}^{SS , BS} - {\sum }_{{bs}^{′} \neq bs ∈ {BS}_{bs}^{OUT , BS}} {f}_{bs , {bs}^{′} , t}^{BS , BS} - {\sum }_{ds ∈ {DS}_{bs}^{OUT , BS}} {f}_{bs , ds , t}^{BS , DS} , \\ ∀ n = ( j , t ) ∈ {N}^{R} , ∀ j ∈ {J}^{{D}_{o}} , ∀ bs ∈ {BS}_{j} . & ( 6 ) \\ {s}_{bs , q , t}^{BS} {i}_{bs , t}^{BS} = {s}_{bs , q , t - 1}^{BS} {i}_{bs , t - 1}^{BS} + {\sum }_{v ∈ V} {\sum }_{ss ∈ SS} {S}_{ss , q}^{SS} {f}_{n , v , ss , bs}^{V , BS} + {\sum }_{{bs}^{′} \neq bs ∈ {BS}_{bs}^{IN , BS}} {s}_{{bs}^{′} , q , t - 1 - {TT}_{{bs}^{′} , bs}^{BS , BS}}^{BS} {f}_{{bs}^{′} , bs , t - {TT}_{{bs}^{′} , bs}^{BS , BS}}^{BS , BS} + {\sum }_{ss ∈ {SS}_{{j}^{′} , bs}^{IN , BS} , {j}^{′} ∈ {J}^{{L}_{PR}}} {S}_{ss , q}^{SS} {f}_{ss , bs , t}^{SS , BS} - {\sum }_{{bs}^{′} \neq bs ∈ {BS}_{bs}^{OUT , BS}} {s}_{bs , q , t - 1}^{BS} {f}_{bs , {bs}^{′} , t}^{BS , BS} - {\sum }_{ds ∈ {DS}_{bs}^{OUT , BS}} {s}_{bs , q , t - 1}^{BS} {f}_{bs , ds , t}^{BS , DS} , \\ ∀ n = ( j , t ) ∈ {N}^{R} , ∀ j ∈ {J}^{{D}_{o}} , ∀ bs ∈ {BS}_{j} , ∀ q ∈ Q . & ( 7 )\end{matrix}$$

The following set of constraints precludes the possibility of (multiple) inputs and (multiple) outputs into any blend tank from occurring on the same day t by enforcing the condition that only (multiple) inputs or only (multiple) outputs or no inputs or outputs can occur on the same day t.

$$\begin{matrix}[ \begin{matrix}{w}_{n , bs}^{1} = 1 \\ {f}_{bs , {bs}^{′} , t}^{BS , BS} = 0 , ∀ {bs}^{′} \neq bs ∈ {BS}_{bs}^{OUT , BS} \\ {f}_{bs , ds , t}^{BS , DS} = 0 , ∀ ds ∈ {DS}_{bs}^{OUT , BS}\end{matrix} ] ⋁ & \begin{matrix} \\ ( 8 ) \\ ( 9 )\end{matrix} \\ [ \begin{matrix}{w}_{n , bs}^{2} = 1 \\ {f}_{n , v , ss , bs}^{V , BS} = 0 , ∀ v ∈ V , ∀ ss ∈ SS \\ {f}_{{bs}^{′} , bs , t}^{BS , BS} = 0 , ∀ {bs}^{′} \neq bs ∈ {BS}_{bs}^{IN , BS} \\ {f}_{ss , bs , t}^{SS , BS} = 0 , ∀ ss ∈ {SS}_{{j}^{′} , bs}^{IN , BS} , {j}^{′} ∈ {J}^{{L}_{PR}}\end{matrix} ] ⋁ & \begin{matrix} \\ ( 10 ) \\ ( 11 ) \\ \\ ( 12 )\end{matrix} \\ [ \begin{matrix}{w}_{n , bs}^{3} = 1 \\ {f}_{bs , {bs}^{′} , t}^{BS , BS} = 0 , ∀ {bs}^{′} \neq bs ∈ {BS}_{bs}^{OUT , BS} \\ {f}_{bs , ds , t}^{BS , DS} = 0 , ∀ ds ∈ {DS}_{bs}^{OUT , BS} \\ {f}_{n , v , ss , bs}^{V , BS} = 0 , ∀ v ∈ V , ∀ ss ∈ SS \\ {f}_{{bs}^{′} , bs , t}^{BS , BS} = 0 , ∀ {bs}^{′} \neq bs ∈ {BS}_{bs}^{IN , BS} \\ {f}_{ss , bs , t}^{SS , BS} = 0 , ∀ ss ∈ {SS}_{{j}^{′} , bs}^{IN , BS} , {j}^{′} ∈ {J}^{{L}_{PR}}\end{matrix} ] & \begin{matrix} \\ ( 13 ) \\ ( 14 ) \\ ( 15 ) \\ \\ ( 16 ) \\ ( 17 )\end{matrix} \\ ∀ n = ( j , t ) ∈ {N}^{R} , ∀ j ∈ {J}^{{D}_{o}} , ∀ bs ∈ {BS}_{j} . & ( 18 ) \\ {w}_{n , bs}^{1} + {w}_{n , bs}^{2} + {w}_{n , bs}^{3} = 1 , ∀ n = ( j , t ) ∈ {N}^{R} , ∀ j ∈ {J}^{{D}_{o}} , \\ ∀ bs ∈ {BS}_{j} . & ( 19 )\end{matrix}$$

Every blend tank in use must be leased for some duration of time. Typically, a tank will be leased on a monthly basis, although longer contracts are possible. Let the set L represent the set of leases for all blend tanks. Furthermore, let the set LM represent the set of calendar months m over the entire modeling time period, and let TMₘ represent the set of calendar days t in month m. Finally, let L_{bs,m}⊂L represent the set of leases that exist for blend tank bs during month m. Then, the binary variable lu_{m,ls} for each mεLM, lsεL takes a value of 1 if the lease ls used in month m and a value of 0 otherwise. The continuous variable lnm_{m,ls,ls′} for each mεLM,ls,ls′εL, whose range is [0,1], necessarily takes a value of 1 (see constrains) if lease ls′ is used in month m+1 and a value of 0 otherwise. The continuous variable laot_{m,ls} for each mεLM,lsεL represents the excess amount of material over 1 tank turn moved through the tank for lease ls in month m. The continuous variable lma_{m,ls}^{IN} for each mεLM,lsεL represents the total amount of material moved into the tank for lease ls in month m. The continuous variable lma_{m,ls}^{OUT} for each mεLM,lsεL represents the total amount of material moved out of the tank for lease ls in month m. Furthermore, for every tank that is leased, we incur a fixed cost CST_{m,ls}^{FX} and a variable cost CST_{m,ls}^{VR}.

The following constraints represent the lease constraints that must hold for every blend tank in order for the latter to be used.

$$\begin{matrix} {lu}_{m , ls} + {w}_{n , bs}^{3} \geq 1 , ∀ ls ∈ {L}_{bs , m} , ∀ m ∈ LM , ∀ bs ∈ {BS}_{j} , \\ ∀ n = ( j , t ) ∈ {N}^{R} , ∀ t ∈ {TM}_{m} , ∀ j ∈ {J}^{{D}_{o}} & ( 20 ) \\ {lma}_{m , ls}^{IN} \leq {TURN}_{ls}^{MAX} {TURN}_{ls}^{AMT} {lu}_{m , ls} , ∀ ls ∈ {L}_{bs , m} , ∀ m ∈ LM & ( 21 ) \\ {lma}_{m , ls}^{OUT} \leq {TURN}_{ls}^{MAX} {TURN}_{ls}^{AMT} {lu}_{m , ls} , ∀ ls ∈ {L}_{bs , m} , ∀ m ∈ LM & ( 22 ) \\ {lma}_{m , ls}^{IN} \geq {\sum }_{v ∈ V} {\sum }_{ss ∈ SS} {f}_{n , v , ss , bs}^{V , BS} + {\sum }_{{bs}^{′} \neq bs ∈ {BS}_{bs}^{IN , BS}} {f}_{{bs}^{′} , bs , t - {TT}_{{bs}^{′} , bs}^{BS , BS}}^{BS , BS} + {\sum }_{ss ∈ {SS}_{{j}^{′} , bs}^{IN , BS} , {j}^{′} ∈ {J}^{{L}_{PR}}} {f}_{ss , bs , t}^{SS , BS} , \\ ∀ ls ∈ {L}_{bs , m} , ∀ m ∈ LM & ( 23 ) \\ {lma}_{m , ls}^{OUT} \geq {\sum }_{{bs}^{′} \neq bs ∈ {BS}_{bs}^{OUT , BS}} {f}_{bs , {bs}^{′} , t}^{BS , BS} - {\sum }_{ds ∈ {DS}_{bs}^{OUT , BS}} {f}_{bs , ds , t}^{BS , DS} , \\ ∀ ls ∈ {L}_{bs , m} , ∀ m ∈ LM & ( 24 ) \\ {laot}_{m , ls} \geq {lma}_{m , ls}^{IN} + {AMT}_{ls}^{IN} - {TURN}_{ls}^{AMT} , \\ ∀ ls ∈ {L}_{bs , m} , ∀ m ∈ LM & ( 25 ) \\ {laot}_{m , ls} \geq {lma}_{m , ls}^{OUT} + {AMT}_{ls}^{OUT} - {TURN}_{ls}^{AMT} , \\ ∀ ls ∈ {L}_{bs , m} , ∀ m ∈ LM & ( 26 ) \\ {I}_{bs , t}^{MIN , BS} {lu}_{m , ls} \leq {i}_{bs , t}^{BS} \leq {I}_{bs , t}^{MAX , BS} {lu}_{m , ls} , ∀ t ∈ {TM}_{m} , {LDM}_{m} , \\ ∀ bs ∈ BS , ∀ ls ∈ {L}_{bs , m} , ∀ m ∈ LM & ( 27 ) \\ {LBAVG}_{bs , q , t} {lu}_{m , ls} \leq {s}_{bs , q , t}^{BS} \leq {UBAVG}_{bs , q , t} {lu}_{m , ls} , ∀ t ∈ {TM}_{m} \\ {LDM}_{m} , ∀ bs ∈ BS , ∀ q ∈ Q , ∀ ls ∈ {L}_{bs , m} , ∀ m ∈ LM & ( 28 ) \\ {I}_{bs , t}^{MIN , BS} {lnm}_{m , ls , {ls}^{′}} \leq {i}_{bs , t}^{BS} \leq {I}_{bs , t}^{MAX , BS} {lnm}_{m , ls , {ls}^{′}} , ∀ t = {LDM}_{m} , \\ ∀ bs ∈ BS , ∀ ls ∈ {L}_{bs , m} , ∀ {ls}^{′} ∈ {L}_{bs , m + 1} ∀ m ∈ LM & ( 29 ) \\ {LBAVG}_{bs , q , t} {lnm}_{m , ls , {ls}^{′}} \leq {s}_{bs , q , t}^{BS} \leq {UBAVG}_{bs , q , t} {lnm}_{m , ls , {ls}^{′}} , \\ ∀ t = {LDM}_{m} , ∀ bs ∈ BS , ∀ q ∈ Q , ∀ ls ∈ {L}_{bs , m} , \\ ∀ {ls}^{′} ∈ {L}_{bs , m + 1} ∀ m ∈ LM & ( 30 ) \\ {lnm}_{m , ls , {ls}^{′}} \leq {lu}_{m , ls} , ∀ bs ∈ BS , ∀ ls ∈ {L}_{bs , m} , \\ ∀ {ls}^{′} ∈ {L}_{bs , m + 1} , ∀ m ∈ LM & ( 31 ) \\ {lnm}_{m , ls , {ls}^{′}} \leq {lu}_{m + 1 , ls} , ∀ bs ∈ BS , ∀ ls ∈ {L}_{bs , m} , \\ ∀ {ls}^{′} ∈ {L}_{bs , m + 1} ∀ m ∈ LM & ( 32 ) \\ {lu}_{m , ls} + {lu}_{m + 1 , ls} \leq {lnm}_{m , ls , {ls}^{′}} + 1 , ∀ bs ∈ BS , \\ ∀ ls ∈ {L}_{bs , m} , ∀ {ls}^{′} ∈ {L}_{bs , m + 1} ∀ m ∈ LM . & ( 33 )\end{matrix}$$

The following set of constraints ensures inventory balances for the ships.

$${i}_{v , ss , t}^{V} = {i}_{v , ss , t - 1}^{V} + {\sum }_{\{ n = ( j , t ) , ss ∈ {SS}_{j} : j ∈ {J}^{{L}_{O}} \}} {f}_{n , ss , v}^{SS , V} - {\sum }_{\{ n = ( j , t ) , ds ∈ {DS}_{j} : j ∈ {J}^{D} \}} {f}_{n , v , ss , ds}^{V , DS} - {\sum }_{\{ n = ( j , t ) , bs ∈ {BS}_{j} : j ∈ {J}^{{D}_{O}} \}} {f}_{n , v , ss , bs}^{V , BS} , \\ ∀ ss ∈ SS , ∀ t ∈ \{ 1 , 2 , … , T \} , ∀ v ∈ V . \qquad ( 34 )$$

Loads and discharges by a ship can occur only when the ship is at that port. If a load or discharge occurs, the total loading amount or total discharging amount (via ship only) is forced to be between the port specific minimum and maximum amounts. These are represented by the following constraints.

$$\begin{matrix} {z}_{n , v} \leq {\sum }_{\{ a ∈ {A}_{v} : a ∈ {δ}^{-} ( n ) \}} {x}_{a} , ∀ n ∈ {N}^{R} , ∀ v ∈ V , & ( 35 ) \\ {F}_{j}^{MIN} {z}_{n , v} \leq {\sum }_{ss ∈ {SS}_{j}} {f}_{n , ss , v}^{SS , V} \leq {F}_{j}^{MAX} {z}_{n , v} , ∀ j ∈ {J}^{{L}_{o}} , \\ ∀ n = ( j , t ) ∈ {N}^{R} , ∀ v ∈ V , & ( 36 ) \\ {F}_{j}^{MIN} {z}_{n , v} \leq {\sum }_{ds ∈ {DS}_{j}} {\sum }_{ss ∈ SS} {f}_{n , v , ss , ds}^{V , DS} + {\sum }_{bs ∈ {BS}_{j}} {\sum }_{ss ∈ SS} {f}_{n , v , ss , bs}^{V , BS} \leq {F}_{j}^{MAX} {z}_{n , v} , \\ ∀ j ∈ {J}^{D} , ∀ n = ( j , t ) ∈ {N}^{R} , ∀ v ∈ V , & ( 37 )\end{matrix}$$

Only one ship may stop for load or discharge at a port at a time. The following set of constraints ensures that this is true. If more than one ship can stop at a port at a time, the right hand side can be adjusted appropriately as necessary.

$${\sum }_{v ∈ V} {z}_{n , v} \leq 1 ∀ n ∈ {N}^{R} . \qquad ( 38 )$$

The following constraints ensure that a ship cannot load/discharge more than Uⱼ times at port j.

$${\sum }_{n = ( j , t ) ∈ {N}^{R}} {z}_{n , v} \leq {U}_{j} , ∀ v ∈ V , ∀ j ∈ J . \qquad ( 39 )$$

Every blend tank stream has daily-average lower and upper property specifications—LBAVG_{bs,q,t} and UBAVG_{bs,q,t} with bsεBS, tε{1, 2, . . . , T} and qεQ, respectively—that must be satisfied at the end of every time period t (e.g., each day). Note that these bounds do not enforce any specification on any individual stream entering the tank at any point in time. Furthermore, every demand stream has hard upper and lower property specifications, or bounds. These hard bounds represent acceptability of product. The following set of constraints ensures that the supply streams blended onboard every vessel and discharged into a demand stream, as well as every individual blend tank stream discharged into a demand stream meet these property specifications. We note that the quantity of product discharged from blend tank stream bs into demand stream ds must take a value within the interval bounded by F_{bs,t}^{MIN,BS} and F_{bs,t}^{MAX,BS}.

$$\begin{matrix}{LBH}_{ds , q} {\sum }_{ss ∈ SS} {f}_{n , v , ss , ds}^{V , DS} \leq {\sum }_{ss ∈ SS} {S}_{ss , q}^{SS} {f}_{n , v , ss , ds}^{V , DS} \leq {UBH}_{ds , q} {\sum }_{ss ∈ SS} {f}_{n , v , ss , ds}^{V , DS} , \\ ∀ v ∈ V , ∀ n = ( j , t ) ∈ {N}^{R} , ∀ j ∈ {J}^{D} , ∀ ds ∈ {DS}_{j} , ∀ q ∈ Q , & ( 40 ) \\ {LBH}_{ds , q} {y}_{bs , ds , t} + {LBAVG}_{bs , q , t - 1} ( 1 - {y}_{bs , ds , t} ) \leq {s}_{bs , q , t - 1}^{BS} \leq {UBH}_{ds , q} {y}_{bs , ds , t} + {UBAVG}_{bs , q , t - 1} ( 1 - {y}_{bs , ds , t} ) , \\ ∀ j ∈ {J}^{D} , ∀ ds ∈ {DS}_{j} , ∀ bs ∈ {BS}_{ds}^{IN , DS} , \\ ∀ q ∈ Q , ∀ t ∈ \{ 1 , 2 , … , T \} , & ( 41 ) \\ {F}_{bs , t}^{MIN , BS} {y}_{bs , ds , t} \leq {f}_{bs , ds , t}^{BS , DS} \leq {F}_{bs , t}^{MAX , BS} {y}_{bs , ds , t} , \\ ∀ j ∈ {J}^{D} , ∀ ds ∈ {DS}_{j} , ∀ bs ∈ {BS}_{ds}^{IN , DS} , ∀ q ∈ Q , \\ ∀ t ∈ \{ 1 , 2 , … , T \} . & ( 42 )\end{matrix}$$

The following set of constraints deal with the specification adjusted valuation of discharged products that are blended on-board the vessel.

$$\begin{matrix}{sav}_{n , v , ds , q}^{V , DS} \leq \frac{{VS}_{ds , q}^{DS}}{{VBU}_{q}} ( \begin{matrix}{STD}_{ds , q}^{DS} {\sum }_{ss ∈ SS} {S}_{ss , q}^{SS} {f}_{n , v , ss , ds}^{V , DS} - \\ {\sum }_{ss ∈ SS} {S}_{ss , q}^{SS} {f}_{n , v , ss , ds}^{V , DS}\end{matrix} ) , \\ ∀ v ∈ V , ∀ n = ( j , t ) ∈ {N}^{R} , ∀ j ∈ {J}^{D} , ∀ ds ∈ {DS}_{j} , ∀ q ∈ \underline{Q} , & ( 43 ) \\ {sav}_{n , v , ds , q}^{V , DS} \leq \frac{{VS}_{ds , q}^{DS}}{{VBU}_{q}} ( {STD}_{ds , q}^{DS} - {LBS}_{ds , q}^{DS} ) {\sum }_{ss ∈ SS} {f}_{n , v , ss , ds}^{V , DS} , \\ ∀ v ∈ V , ∀ n = ( j , t ) ∈ {N}^{R} , ∀ j ∈ {J}^{D} , ∀ ds ∈ {DS}_{j} , ∀ q ∈ \underline{Q} , & ( 44 ) \\ {sav}_{n , v , ds , q}^{V , DS} \leq \frac{{VS}_{ds , q}^{DS}}{{VBU}_{q}} ( {\sum }_{ss ∈ SS} {S}_{ss , q}^{SS} {f}_{n , v , ss , ds}^{V , DS} - {STD}_{ds , q}^{DS} {\sum }_{ss ∈ SS} {f}_{n , v , ss , ds}^{V , DS} ) , \\ ∀ v ∈ V , ∀ n = ( j , t ) ∈ {N}^{R} , ∀ j ∈ {J}^{D} , ∀ ds ∈ {DS}_{j} , ∀ q ∈ \overline{Q} , & ( 45 ) \\ {sav}_{n , v , ds , q}^{V , DS} \leq \frac{{VS}_{ds , q}^{DS}}{{VBU}_{q}} ( {UBS}_{ds , q}^{DS} - {STD}_{ds , q}^{DS} ) {\sum }_{ss ∈ SS} {f}_{n , v , ss , ds}^{V , DS} , \\ ∀ v ∈ V , ∀ n = ( j , t ) ∈ {N}^{R} , ∀ j ∈ {J}^{D} , ∀ ds ∈ {DS}_{j} , ∀ q ∈ \overline{Q} , & ( 46 )\end{matrix}$$

The following set of constraints deal with the specification adjusted valuation of discharged product from blend tank streams to demand streams.

$$\begin{matrix}{sav}_{bs , ds , q , t}^{BS , DS} \leq \frac{{VS}_{ds , q}^{DS}}{{VBU}_{q}} ( {STD}_{ds , q}^{DS} {f}_{bs , ds , t}^{BS , DS} - {s}_{bs , q , t - 1}^{BS} {f}_{bs , ds , t}^{BS , DS} ) , \\ ∀ j ∈ {J}^{D} , ∀ ds ∈ {DS}_{j} , ∀ bs ∈ {BS}_{ds}^{IN , DS} , ∀ q ∈ \underline{Q} , \\ ∀ t ∈ \{ 1 , 2 , … , T \} , & ( 47 ) \\ {sav}_{bs , ds , q , t}^{BS , DS} \leq \frac{{VS}_{ds , q}^{DS}}{{VBU}_{q}} ( {STD}_{ds , q}^{DS} - {LBS}_{ds , q}^{DS} ) {f}_{bs , ds , t}^{BS , DS} , \\ ∀ j ∈ {J}^{D} , ∀ ds ∈ {DS}_{j} , ∀ bs ∈ {BS}_{ds}^{IN , DS} , ∀ q ∈ \underline{Q} , \\ ∀ t ∈ \{ 1 , 2 , … , T \} , & ( 48 ) \\ {sav}_{bs , ds , q , t}^{BS , DS} \leq \frac{{VS}_{ds , q}^{DS}}{{VBU}_{q}} ( {s}_{bs , q , t - 1}^{BS} {f}_{bs , ds , t}^{BS , DS} - {STD}_{ds , q}^{DS} {f}_{bs , ds , t}^{BS , DS} ) , \\ ∀ j ∈ {J}^{D} , ∀ ds ∈ {DS}_{j} , ∀ bs ∈ {BS}_{ds}^{IN , DS} , ∀ q ∈ \overline{Q} , \\ ∀ t ∈ \{ 1 , 2 , … , T \} , & ( 49 ) \\ {sav}_{bs , ds , q , t}^{BS , DS} \leq \frac{{VS}_{ds , q}^{DS}}{{VBU}_{q}} ( {UBS}_{ds , q}^{DS} - {STD}_{ds , q}^{DS} ) {f}_{bs , ds , t}^{BS , DS} , \\ ∀ j ∈ {J}^{D} , ∀ ds ∈ {DS}_{j} , ∀ bs ∈ {BS}_{ds}^{IN , DS} , ∀ q ∈ \overline{Q} , \\ ∀ t ∈ \{ 1 , 2 , … , T \} . & ( 50 )\end{matrix}$$

The following set of constraints enforces draft limits. Without loss of generality, it is assumed that draft limits for ship v are less than or equal to ship v's capacity Iᵥ^{MAX,V}.

$$\begin{matrix}{\sum }_{ss ∈ SS} {i}_{v , ss , t - 1}^{V} \leq {DL}_{vjt}^{IN} + ( {I}_{v}^{MA X , V} - {DL}_{vjt}^{IN} ) ( 1 - {z}_{n , v} ) , \\ ∀ n = ( j , t ) ∈ {N}^{R} ∀ v ∈ V , & ( 51 ) \\ {\sum }_{ss ∈ SS} {i}_{v , ss , t}^{V} \leq {DL}_{vjt}^{OUT} + ( {I}_{v}^{MA X , V} - {DL}_{vjt}^{OUT} ) ( 1 - {z}_{n , v} ) , \\ ∀ n = ( j , t ) ∈ {N}^{R} ∀ v ∈ V . & ( 52 )\end{matrix}$$

Overage calculations can be taken care of as follows. Without loss of generality, it is assumed that the capacity of ship Iᵥ^{MAX,V} is greater than or equal to its base amount Bᵥ.

$$\begin{matrix}{o}_{v} \geq {\sum }_{ss ∈ SS} {i}_{v , ss , t}^{V} - {B}_{v} , ∀ v ∈ V , ∀ t ∈ \{ 1 , 2 , … , T \} , & ( 53 ) \\ {o}_{a , v} \geq {o}_{v} - ( {I}_{v}^{MA X , V} - {B}_{v} ) ( 1 - {x}_{a} ) , ∀ v ∈ V , ∀ a ∈ {A}_{v}^{T} . & ( 54 )\end{matrix}$$

The following set of constraints ensures that a ship may not carry products in excess of its cargo capacity.

$${\sum }_{ss ∈ SS} {i}_{v , ss , t}^{V} \leq {I}_{v}^{MA X , V} , ∀ t ∈ \{ 1 , 2 , … , T \} , ∀ v ∈ V . \qquad ( 55 )$$

The final set of constraints provides the bounds on all variables.

xₐε{0,1}, ∀aεA^{v}∀vεV, (56)

z_{n,v}ε{0,1}, ∀nεN^{R}∀vεV, (57)

w_{n,bs}¹ε{0,1}, ∀nεN^{R}∀bsεBS, (58)

w_{n,bs}²ε{0,1}, ∀nεN^{R}∀bsεBS, (59)

w_{n,bs}³ε{0,1}, ∀nεN^{R}∀bsεBS, (60)

y_{bs,ds,t}ε{0,1}, ∀dsεDS_{bs}^{OUT,BS}, ∀bsεBS, ∀tε{1, 2, . . . , T}, (61)

Iₛₛ^{MIN,SS}≦i_{ss,t}^{SS}≦I_{ss,t}^{MAX,SS}, ssεSS, tε{1, 2, . . . , T}, (62)

I_{ds,t}^{MIN,DS}≦i_{ds,t}^{DS}≦I_{ds,t}^{MAX,DS}, dsεDS, tε{1, 2, . . . , T}, (63)

I_{bs,t}^{MIN,BS}≦i_{bs,t}^{BS}≦I_{bs,t}^{MAX,BS}, bsεBS, tε{1, 2, . . . , T}, (64)

f_{n,ss,v}^{SS,V}≧0, ∀n=(j,t)εN^{R}, ∀ssεSS, ∀vεV, (65)

f_{n,v,ss,ds}^{V,DS}≧0, ∀n=(j,t)εN^{R}, ∀dsεDS, ∀ssεSS, ∀vεV, (66)

f_{n,v,ss,bs}^{V,BS}≧0, ∀n=(j,t)εN^{R}, ∀bsεBS, ∀ssεSS, ∀vεV, (67)

f_{ss,ds,t}^{SS,DS}≧0, ∀dsεDS, ∀ssεSS_{j′,ds}^{IN,DS}, j′εJ^{L}^{_{PR}}, tε{1, 2, . . . , T}, (68)

f_{ss,bs,t}^{SS,BS}≧0, ∀bsεBS, ∀ssεSS_{j′,bs}^{IN,BS}, j′εJ^{L}^{_{PR}}, tε{1, 2, . . . , T}, (69)

0≦f_{bs′,bs,t}^{BS,BS}≦F_{bs′}^{MAX,BS}, ∀bsεBS, ∀bs′≠bsεBS, tε{1, 2, . . . , T}, (70)

LBAVG_{bs,q,t}≦s_{bs,q,t}^{BS}≦UBAVG_{bs,q,t}, ∀bsεBS, ∀qεQ, tε{1, 2, . . . , T}, (71)

i_{v,ss,t}^{V}0, ∀ssεSS, ∀tε{1, 2, . . . , T}, ∀vεV, (72)

0≦o_{a,v}≦Iᵥ^{MAX,V}−Bᵥ, ∀aεAᵥ^{T} •vεV, (73)

0≦oᵥ≦Iᵥ^{MAX,V}−Bᵥ, ∀vεV. (74)

The objective is to maximize profit. The profit is defined by values of discharged product plus values of final inventories of blend tanks minus values of loaded product minus values of initial blend tank inventories minus all the transportation related costs.

$$max {\sum }_{v ∈ V} {\sum }_{n = ( j , t ) ∈ {N}^{R}} {\sum }_{ds ∈ {DS}_{j}} {\sum }_{ss ∈ SS} {VLB}_{ds}^{DS} {f}_{n , v , ss , ds}^{V , DS} + {\sum }_{v ∈ V} {\sum }_{n = ( j , t ) ∈ {N}^{R}} {\sum }_{ds ∈ {DS}_{j}} {\sum }_{q ∈ Q} {sav}_{n , v , ds , q}^{V , DS} + {\sum }_{j ∈ {J}^{D}} {\sum }_{ds ∈ {DS}_{j}} {\sum }_{bs ∈ {BS}_{ds}^{IN , DS}} {\sum }_{t} {VLB}_{ds}^{DS} {f}_{bs , ds , t}^{BS , DS} + {\sum }_{j ∈ {J}^{D}} {\sum }_{ds ∈ {DS}_{j}} {\sum }_{bs ∈ {BS}_{ds}^{IN , DS}} {\sum }_{t} {\sum }_{q ∈ Q} {sav}_{bs , ds , q , t}^{BD , DS} - {\sum }_{bs ∈ BS} {VLB}_{bs}^{BS , INIT} {I}_{bs , 0}^{BS} - {\sum }_{bs ∈ BS} {\sum }_{q ∈ Q} {SAV}_{bs , q , 0}^{BS} - {\sum }_{v ∈ V} {\sum }_{n = ( j , t ) ∈ {N}^{R}} {\sum }_{ss ∈ {SS}_{j}} {VL}_{ss}^{SS} {f}_{n , ss , v}^{SS , V} - {\sum }_{v ∈ V} {\sum }_{a ∈ {A}_{v}} {C}_{a} {x}_{a} - {\sum }_{v ∈ V} {OVR}_{v} {WS}_{v} {\sum }_{a ∈ {A}_{v}^{T}} {C}_{a} {o}_{a , v} - {\sum }_{j ∈ {J}^{D}} {\sum }_{ds ∈ {DS}_{j}} {\sum }_{bs ∈ {BS}_{ds}^{IN , DS}} {\sum }_{t} {CST}_{bs , j}^{BG} {f}_{bs , ds , t}^{BS , DS} - {\sum }_{j ∈ {J}^{D}} {\sum }_{{bs}^{′} \neq bs ∈ {BS}_{bs}^{OUT , BS}} {\sum }_{bs ∈ BS} {\sum }_{t} {CST}_{bs , j}^{BG} {f}_{bs , {bs}^{′} , t}^{BS , BS} - {\sum }_{m ∈ M} {\sum }_{ls ∈ LS} {CST}_{m , ls}^{FX} {TURN}_{ls}^{AMT} {lu}_{m , ls} - {\sum }_{m ∈ M} {\sum }_{ls ∈ LS} {CST}_{m , ls}^{VR} {laot}_{m , ls} . \qquad ( 75 )$$

### Solution Technique

A decomposition approach was developed to tackle this large-scale mixed-integer non-linear programming (MINLP) problem. Specifically, this approach has two phases. The first phase transforms the MINLP into a mixed-integer linear programming (MILP) subproblem and solves the resulting MILP subproblem. The solution procedure for the MILP subproblem includes a construction heuristic, an optimization-based large neighborhood search procedure, followed by the solution of an non-linear programming (NLP) subproblem. The second phase solves a sequence of MILP problems.

Transformation from MINLP to MILP

Due to the presence of bilinear terms in constraints involving blend tank specification inventory and valuation, the resulting METEOROID model is both nonlinear and nonconvex in the continuous space. This introduces difficulties into the solution method, and a customized method of transforming the original MINLP problem into a MILP was been developed to circumvent these issues. This transformation, which is described below, guarantees that if a feasible solution to the transformed MILP model is found, then that solution is necessarily feasible for the original MINLP problem. We can thus obtain good solutions to our original MINLP problem by solving the resulting transformed MILP problem through a customized heuristic.

The transformation restricts the functionality of the blend tanks in the model in such a way that new material cannot be input into the tank once discharge begins until substantially all material already in the tank has been fully discharged. This leads to multiple “build and draw cycles” for every tank, where a cycle is typically characterized by monotonically increasing inventory in the tank, followed by monotonically decreasing inventory until the tank is fully drawn out. For clarification of intended meaning, it is understood in this field of art that full emptying of a blending tank does not necessarily mean that the tank is completely empty (dry) after discharge. The term “fully emptied” in this context is understood to mean that the liquid in the tank is discharged down to the lowest level routinely or regularly achieved with that particular tank while it is handling that particular liquid. Further emptying of the tank beyond this point may be impractical for a number of reasons, including the bubble point of the liquid and its effect on net available positive suction head for pumps, the location of the nozzles, the suction head requirements of discharge or loading pumps, constraints on floating roofs (if so equipped), tank integrity requirements in view of possible ground or surface water, sediment or solid residue in the tank, tank hydrocarbon emissions into the air, tank level indicator or control limitations, etc. The liquid that is left in a tank after discharge has been completed is commonly called the “heel” of the tank. The amount of heel after fully emptying a tank will vary from tank to tank and may vary slightly from day to day for a given tank.

In order to implement this transformation, new variables need to be defined, and all constraints in the MINLP model that contain bilinear terms are removed, and the set of constraints described as follows are added. The binary variable zz_{bs,t} takes a value of 1 if tank bs at time t is empty, otherwise it takes the value of 0. The continuous variable ww_{bs,ds,t}, whose range is [0,1], necessarily takes the value of 1 if a discharge from blend tank bs to demand stream ds has occurred at time t and leads to the emptying of the tank at time t (otherwise it necessarily takes the value of 0); we call these discharges “emptying discharges”. Formally, ww_{bs,ds,t}=y_{bs,ds,t} [symbol] zz_{bs,t}. The continuous variable uu_{bs,t}, whose range is [0,1], necessarily takes the value of 1 if no “emptying discharges” occur for blend tank bs to any demand stream ds at time t (otherwise it necessarily takes a value of 0). Formally, uu_{bs,t}= [symbol] _{ds} [symbol] ww_{bs,ds,t}. The continuous variable xx_{bs,ds,t}, whose range is [0,1], necessarily takes the value of 1 if a discharge from blend tank bs to demand stream ds occurs at time t, and no “emptying discharges” occur for that same blend tank bs to any demand stream ds′ at any time t′<t (otherwise it necessarily takes a value of 0). Formally, xx_{bs,ds,t}=y_{bs,ds,t} [symbol] _{t′<t,ds′} [symbol] (y_{bs,ds′,t′} [symbol] zz_{bs,t′}). Finally, the continuous variable vv_{bs,ds,t,t′}, whose range is [0,1], takes a value of 1 if a discharge occurs from blend tank bs to demand stream ds at time t and an “emptying discharge” occurs from that same blend tank bs to some demand stream ds′ at some time t′<t and no emptying discharges occur at any time t′<t″<t. Formally, vv_{bs,ds,t,t′}=y_{bs,ds,t} [symbol] [symbol] _{ds′}ww_{bs,ds′,t′} [symbol] _{t′<t″<t}uu_{bs,t″}.

The following constraints are needed in the transformed model to connect the various variables previously defined together.

$$\begin{matrix}{ww}_{bs , ds , t} \leq {y}_{bs , ds , t} , ∀ bs ∈ {BS}_{ds}^{IN , DS} , ∀ ds ∈ DS , \\ t ∈ \{ 1 , 2 , … , T \} & ( 76 ) \\ {ww}_{bs , ds , t} \leq {zz}_{bs , t} , ∀ bs ∈ {BS}_{ds}^{IN , DS} , ∀ ds ∈ DS , \\ t ∈ \{ 1 , 2 , … , T \} & ( 77 ) \\ {y}_{bs , ds , t} + {zz}_{bs , t} \leq 1 + {ww}_{bs , ds , t} , ∀ bs ∈ {BS}_{ds}^{IN , DS} , ∀ ds ∈ DS , \\ t ∈ \{ 1 , 2 , … , T \} & ( 78 ) \\ {uu}_{bs , t} + {ww}_{bd , ds , t} \leq 1 , ∀ bs ∈ {BS}_{ds}^{IN , DS} , ∀ ds ∈ DS , \\ t ∈ \{ 1 , 2 , … , T \} & ( 79 ) \\ {\sum }_{ds ∈ DS , bs ∈ {BS}_{ds}^{IN , DS}} {ww}_{bs , ds , t} + {uu}_{bs , t} \geq 1 , \\ ∀ bs ∈ BS , t ∈ \{ 1 , 2 , … , T \} & ( 80 ) \\ {xx}_{bs , ds , t} \leq {y}_{bs , ds , t} , ∀ bs ∈ {BS}_{ds}^{IN , DS} , ∀ ds ∈ DS , \\ t ∈ \{ 1 , 2 , … , T \} & ( 81 ) \\ {xx}_{bs , ds , t} \leq {uu}_{bs , {t}^{′}} , ∀ bs ∈ {BS}_{ds}^{IN , DS} , ∀ ds ∈ DS , \\ {t}^{′} < t ∈ \{ 1 , 2 , … , T \} & ( 82 ) \\ {y}_{bs , ds , t} \leq {xx}_{bs , ds , t} + {\sum }_{{t}^{′} \vert {t}^{′} < t} ( 1 - {uu}_{bs , {t}^{′}} ) , \\ ∀ bs ∈ {BS}_{ds}^{IN , DS} , ∀ ds ∈ DS , t ∈ \{ 1 , 2 , … , T \} & ( 83 ) \\ {vv}_{bs , ds , t , {t}^{′}} \leq {y}_{bs , ds , t} , ∀ bs ∈ {BS}_{ds}^{IN , DS} , ∀ ds ∈ DS , \\ {t}^{′} < t ∈ \{ 1 , 2 , … , T \} & ( 84 ) \\ {vv}_{bs , ds , t , {t}^{′}} \leq {\sum }_{{ds}^{′} ∈ DS , bs ∈ {BS}_{{ds}^{′}}^{IN , DS}} {ww}_{bs , ds , t} , ∀ bs ∈ {BS}_{ds}^{IN , DS} , \\ ∀ ds ∈ DS , {t}^{′} < t ∈ \{ 1 , 2 , … , T \} & ( 85 ) \\ {vv}_{bs , ds , t , {t}^{′}} \leq {uu}_{bs , {t}^{″}} , ∀ bs ∈ {BS}_{ds}^{IN , DS} , ∀ ds ∈ DS , \\ {t}^{′} < {t}^{″} ∈ \{ 1 , 2 , … , T \} & ( 86 ) \\ {y}_{bs , ds , t} \leq {uu}_{bs , {t}^{′}} + {\sum }_{{t}^{″} \vert {t}^{′} < {t}^{″} < t} ( 1 - {uu}_{bs , {t}^{″}} ) + {vv}_{bs , ds , t , {t}^{′}} , \\ ∀ bs ∈ {BS}_{ds}^{IN , DS} , ∀ ds ∈ DS , {t}^{′} < t ∈ \{ 1 , 2 , … , T \} & ( 87 ) \\ {y}_{bs , ds , t} \leq {w}_{n , bs}^{2} + {zz}_{bs , t} , ∀ n = ( j , t ) ∈ {N}^{R} , \\ ∀ bs ∈ {BS}_{ds}^{IN , DS} ⋂ {BS}_{j} , ∀ ds ∈ DS & ( 88 ) \\ {y}_{bs , ds , t} \leq {w}_{n , bs}^{2} + {zz}_{bs , t} , ∀ n = ( j , t + 1 ) ∈ {N}^{R} , \\ ∀ bs ∈ {BS}_{ds}^{IN , DS} ⋂ {BS}_{j} , ∀ ds ∈ DS & ( 89 ) \\ {w}_{n , bs}^{2} \leq {w}_{{n}^{′} , bs}^{2} + {zz}_{bs , t} , ∀ n = ( j , t ) , {n}^{′} = ( j , t + 1 ) ∈ {N}^{R} , \\ ∀ bs ∈ {BS}_{ds}^{IN , DS} ⋂ {BS}_{j} , ∀ ds ∈ DS . & ( 90 )\end{matrix}$$

The next set of constraints enforce the restriction on the functionality of the blend tanks

$$\begin{matrix}⋁ [ \begin{matrix}{xx}_{bs , ds , t} = 1 \\ \begin{matrix}{LBH}_{ds , q} \leq {\sum }_{v ∈ V} {\sum }_{ss ∈ SS} {\sum }_{n = ( j , {t}^{′} ) \vert {t}^{′} < t} {S}_{ss , q}^{SS} {f}_{n , v , ss , bs}^{V , BS} + \\ {\sum }_{ss ∈ {SS}_{{j}^{′} , bs}^{IN , BS} , {j}^{′} ∈ {J}^{{L}_{PR}}} {\sum }_{{t}^{′} \vert {t}^{′} < t} {S}_{ss , q}^{SS} {f}_{ss , bs , {t}^{′}}^{SS , BS} \leq {UBH}_{ds , q}\end{matrix}\end{matrix} ] & \begin{matrix}\begin{matrix}\begin{matrix}\begin{matrix} \\ ( 91 )\end{matrix} \\ \end{matrix} \\ \end{matrix} \\ ( 92 )\end{matrix} \\ ⋁ [ \begin{matrix}{xx}_{bs , ds , t} = 0 \\ \begin{matrix}{LBAVG}_{bs , q , t} \leq {\sum }_{v ∈ V} {\sum }_{ss ∈ SS} {\sum }_{n = ( j , {t}^{′} ) \vert {t}^{′} < t} {S}_{ss , q}^{SS} {f}_{n , v , ss , bs}^{V , BS} + \\ {\sum }_{ss ∈ {SS}_{{j}^{′} , bs}^{IN , BS} , {j}^{′} ∈ {J}^{{L}_{PR}}} {\sum }_{{t}^{′} \vert {t}^{′} < t} {S}_{ss , q}^{SS} {f}_{ss , bs , {t}^{′}}^{SS , BS} \leq {UBAVG}_{bs , q , t}\end{matrix}\end{matrix} ] & \begin{matrix}( 93 ) \\ \begin{matrix} \\ \begin{matrix} \\ ( 94 )\end{matrix}\end{matrix}\end{matrix} \\ ∀ j ∈ {J}^{D} , ∀ ds ∈ {DS}_{j} , ∀ bs ∈ {BS}_{ds}^{IN , DS} , ∀ q ∈ Q , \\ ∀ t ∈ \{ 1 , 2 , … , T \} , & \begin{matrix}( 95 ) \\ \end{matrix} \\ [ \begin{matrix}{vv}_{bs , ds , t , {tt}^{″}} = 1 \\ \begin{matrix}{LBH}_{ds , q} \leq {\sum }_{v ∈ V} {\sum }_{ss ∈ SS} {\sum }_{n = ( j , {t}^{′} ) \vert {t}^{″} < {t}^{′} < t} {S}_{ss , q}^{SS} {f}_{n , v , ss , bs}^{V , BS} + \\ {\sum }_{ss ∈ {SS}_{{j}^{′} , bs}^{IN , BS} , {j}^{′} ∈ {J}^{{L}_{PR}}} {\sum }_{{t}^{′} \vert {t}^{″} < {t}^{′} < t} {S}_{ss , q}^{SS} {f}_{ss , bs , {t}^{′}}^{SS , BS} \leq {UBH}_{ds , q}\end{matrix}\end{matrix} ] & \begin{matrix}\begin{matrix}\begin{matrix}( 96 ) \\ \end{matrix} \\ \end{matrix} \\ ( 97 )\end{matrix} \\ [ \begin{matrix}{vv}_{bs , ds , t , {tt}^{″}} = 0 \\ \begin{matrix}{LBAVG}_{bs , q , t} \leq {\sum }_{v ∈ V} {\sum }_{ss ∈ SS} {\sum }_{n = ( j , {t}^{′} ) \vert {t}^{″} < {t}^{′} < t} {S}_{ss , q}^{SS} {f}_{n , v , ss , bs}^{V , BS} + \\ {\sum }_{ss ∈ {SS}_{{j}^{′} , bs}^{IN , BS} , {j}^{′} ∈ {J}^{{L}_{PR}}} {\sum }_{{t}^{′} \vert {t}^{″} , {t}^{′} < t} {S}_{ss , q}^{SS} {f}_{ss , bs , {t}^{′}}^{SS , BS} \leq {UBAVG}_{bs , q , t}\end{matrix}\end{matrix} ] & \begin{matrix}\begin{matrix}\begin{matrix}( 98 ) \\ \end{matrix} \\ \end{matrix} \\ ( 99 )\end{matrix} \\ ∀ j ∈ {J}^{D} , ∀ ds ∈ {DS}_{j} , ∀ bs ∈ {BS}_{ds}^{IN , DS} , ∀ q ∈ Q , \\ ∀ t , {t}^{″} \vert {t}^{″} < t ∈ \{ 1 , 2 , … , T \} . & ( 100 )\end{matrix}$$

Note that because of the nature of the transformation, it cannot accommodate transfers from blend tank to blend tank. This drawback is addressed in phase 2 of the algorithm.

### Construction Heuristic

The goal of the Construction Heuristic developed here is to quickly find a feasible solution to the transformed MILP problem described above such that the improvement heuristics developed below can use this feasible solution as an initial starting solution. The brute force method of achieving this goal would be to run a Branch-and-Cut algorithm on the full MILP model until it finds a feasible solution. Such a method is unacceptable because in typical cases it is computationally intensive to find a feasible solution due to the problem complexity. Due to this, instead of using the full model to find a feasible solution, a reduced model is built in such a way that any of its feasible solution is also a feasible solution to the original full model. The reduced model which is smaller than the full model increases the likelihood of finding a feasible solution faster. The reduced model has been used successfully in practice to find an initial solution. The present invention contemplates other ways of designing construction heuristics. Also, since different initial solutions can produce different final solutions, several construction heuristics may be used and the final solutions compared.

The idea of the reduced model for the Construction Heuristic is simple: instead of allowing each ship to be able to visit any load port, accessible load ports are restricted for each ship based on production schedules for load ports and available dates for ships. Algorithm 1 below shows how it is decided which ship is accessible to which load port in the reduced model for the Construction Heuristic. The size of the reduced model is controlled with the parameter AF, which is short for Aggressiveness Factor for the Construction Heuristic. Other ways to reduce the complexity of the model by restricting the feasible space include, for example, restricting the loading/discharge time windows for the blending tanks, restricting the supply stream and/or the demand stream to or from a blending tank, or a combination thereof.

Algorithm 1. Construction of reduced model

```
Set K_{j,t} = max{0, LLB_{j,t}}, ∀j ∈ J^{L} {1, 2, . . . , T}
Set Tᵥ to the earliest available time of ship v ∈ V
Set Acc_{j,v} = 0 ∀j ∈ J^{L} ∀v ∈ V
Set count = 0
While count < AF do
  j′ = argminⱼ{K_{j,t} | K_{j,t} ≧ 1}
  v′ = argminᵥ{Tᵥ}
  Acc_{j′,v′} = 1
  For t do
    if K_{j′,t} ≧ 1 then
    K_{j′,t} = K_{j′,t} − 1
    End if
  End for
  $If {\sum }_{j , t} {K}_{j , t} = 0 then$
  Set K_{j,t} = max{0, LLB_{j,t}}, ∀j ∈ J^{L} ∀t ∈ {1, 2, . . . , T}
  count = count + 1
  End if
  T_{v′} = T + 1
  If minᵥ{Tᵥ} = T + 1 then
    Set Tᵥ to the earliest available time of ship v ∈ V
  End if
End While
```

Ship v can visit load port j only when Acc_{j,v}=1 in the reduced model. That means that if Acc_{j,v}=0, all associated arcs are removed in the reduced model. The default value of AF used in practice is 2, which seems to work well most of the time. If the reduced model is infeasible, AF is increased to 3 or 4 to build a new reduced model for the Construction Heuristic. The Construction Heuristic applies the Branch-and-Cut algorithm introduced earlier to this reduced model. It stops at the first feasible solution or after a predetermined run-time expires without finding a feasible solution. These procedures all collectively compose the Construction Heuristic. It is possible that the Construction Heuristic can fail to find an initial solution even though the original model is feasible. However, in practice, this rarely happens. When the Construction Heuristic fails, the original MINLP model is used to find an initial feasible solution by applying an outer approximation algorithm.

### Time/Volume Routing Optimization

When a feasible solution is available, a Time/Volume Routing (TVR) optimization problem can be generated by fixing route information of each ship based on the feasible solution. The TVR algorithm seeks to sequentially solve various TVR optimization problems with different routes fixed. There are various ways of doing this, and we present our current implementation.

Let xₐ be the feasible solution from which we generate a TVR optimization problem. Fixing the route information for each ship is performed by adding the following constraints to the original problem

$$\begin{matrix}{\sum }_{\{ a = ( v , ( 0 , 0 ) , ( j , t ) ∈ A ) \}} {x}_{a} = {\sum }_{\{ a = ( v , ( 0 , 0 ) , ( j , t ) ∈ A ) \}} {x}_{a} , ∀ v ∈ V , ∀ j ∈ J , & ( 101 ) \\ {\sum }_{\{ a = ( v , ( j , t ) , ( 0 , T + 1 ) ∈ A ) \}} {x}_{a} = {\sum }_{\{ a = ( v , ( j , t ) , ( 0 , T + 1 ) ∈ A ) \}} {x}_{a} , ∀ v ∈ V , ∀ j ∈ J , & ( 102 )\end{matrix}$$

as well as some, all or none of the following constraints depending on the phase of the TVR algorithm.

$$\begin{matrix}{\sum }_{\{ a = ( v , ( j , t ) , ( {j}^{′} , {t}^{′} ) ∈ {A}_{T} ) \}} {x}_{a} = {\sum }_{\{ a = ( v , ( j , t ) , ( {j}^{′} , {t}^{′} ) ∈ {A}_{T} ) \}} {x}_{a} , \\ ∀ v ∈ V , ∀ j ∈ {J}^{L} , ∀ {j}^{′} ∈ {J}^{L} , j \neq {j}^{′} , & ( 103 ) \\ {\sum }_{\{ a = ( v , ( j , t ) , ( {j}^{′} , {t}^{′} ) ∈ {A}_{T} ) \}} {x}_{a} = {\sum }_{\{ a = ( v , ( j , t ) , ( {j}^{′} , {t}^{′} ) ∈ {A}_{T} ) \}} {x}_{a} , \\ ∀ v ∈ V , ∀ j ∈ {J}^{L} , ∀ {j}^{′} ∈ {J}^{D} , j \neq {j}^{′} , & ( 104 ) \\ {\sum }_{\{ a = ( v , ( j , t ) , ( {j}^{′} , {t}^{′} ) ∈ {A}_{T} ) \}} {x}_{a} = {\sum }_{\{ a = ( v , ( j , t ) , ( {j}^{′} , {t}^{′} ) ∈ {A}_{T} ) \}} {x}_{a} , \\ ∀ v ∈ V , ∀ j ∈ {J}^{D} , ∀ {j}^{′} ∈ {J}^{D} , j \neq {j}^{′} , & ( 105 )\end{matrix}$$

Algorithm 2 below describes the TVR algorithm. Note that the solution of the above subproblems is done heuristically by using the solution polishing option in CPLEX. This is because guaranteeing optimality at every sub-step of the algorithm through an exact method can become prohibitively expensive, especially for large instances of the original problem.

Algorithm 2. Time/Volume Routing Algorithm

Add constraints (101), (102) and (103), (104), (105) to transformed
MILP problem.
Solve new subproblem and update xₐ.
Add constraints (101), (102) and (103), (104) to transformed MILP
problem. Solve new subproblem and update xₐ.
Add constraints (101), (102) and (103), (105) to transformed MILP
problem. Solve new subproblem and update xₐ.
Add constraints (101), (102) and (104), (105) to transformed MILP
problem. Solve new subproblem and update xₐ.
Add constraints (101), (102) and (103) to transformed MILP problem.
Solve new subproblem and update xₐ.
Add constraints (101), (102) and (104) to transformed MILP problem.
Solve new subproblem and update xₐ.
Add constraints (101), (102) and (105) to transformed MILP problem.
Solve new subproblem and update xₐ.
Solve transformed MILP problem without adding any of the
aforementioned constraints.
Update xₐ.

### NLP Subproblem

Once a feasible solution from the transformed mixed-integer linear programming (MILP) subproblem is obtained, that solution is fixed in the original mixed-integer non-linear programming (MINLP) problem and a non-linear programming (NLP) subproblem is solved. Note that the values of all binary and continuous variables obtained at this stage are fixed in the MINLP. However, because certain variables, such as s_{bs,q,r}^{BS}, were removed in the transformed MILP problem because they were not required (but are nonetheless present in the original MINLP), those variables acquire values upon solving the resulting NLP. Assuming that a feasible solution is obtained from the transformed MILP problem, then the solution obtained from the NLP at this stage is guaranteed to be feasible; thus, we obtain a feasible solution to the original MINLP problem.

### Iterative Bilinear Fixing

Recall that the overall algorithm of METEOROID consists of two phases. The first phase ends upon the solution of the aforementioned NLP subproblem, and the second phase begins there after only if the solution obtained from phase 1 utilizes the blend tanks (i.e., there is a discharge from some blend tank to some demand stream); otherwise, phase 2 is skipped and the overall algorithm terminates.

Assuming that some blend tank is indeed used in the phase 1 solution, then we attempt to obtain a better solution in phase 2 of the overall algorithm by removing the aforementioned restriction imposed on the functionality of the blend tanks. Thus, we now allow the blend tanks to be fully functional. In order to do this, an iterative bilinear fixing (IBF) procedure is developed. The latter involves an iterative procedure of fixing one side (i.e., one of the variables) of all bilinear terms in the original MINLP problem, and solving the resulting MILP. This procedure, as currently implemented, iterates between two steps. In the first step, the variables s_{bs,q,t}^{BS}, bsεBS, qεQ, tε{1, 2, . . . , T} are fixed to their values from the previous solution and the resulting MILP solved. In the second step, the variables i_{bs,t}^{BS}, bsεBS, tε{1, 2, . . . , T} and f_{bs,ds,t}^{BS,DS}, bsεBS, dsεDS, tε{1, 2, . . . , T} are fixed to their values from the previous solution and the resulting MILP solved. This iterative two-step procedure terminates when no improvement from the previous step is obtained, or when a pre-determined stopping criteria is reached.

### Overall Solution Procedure

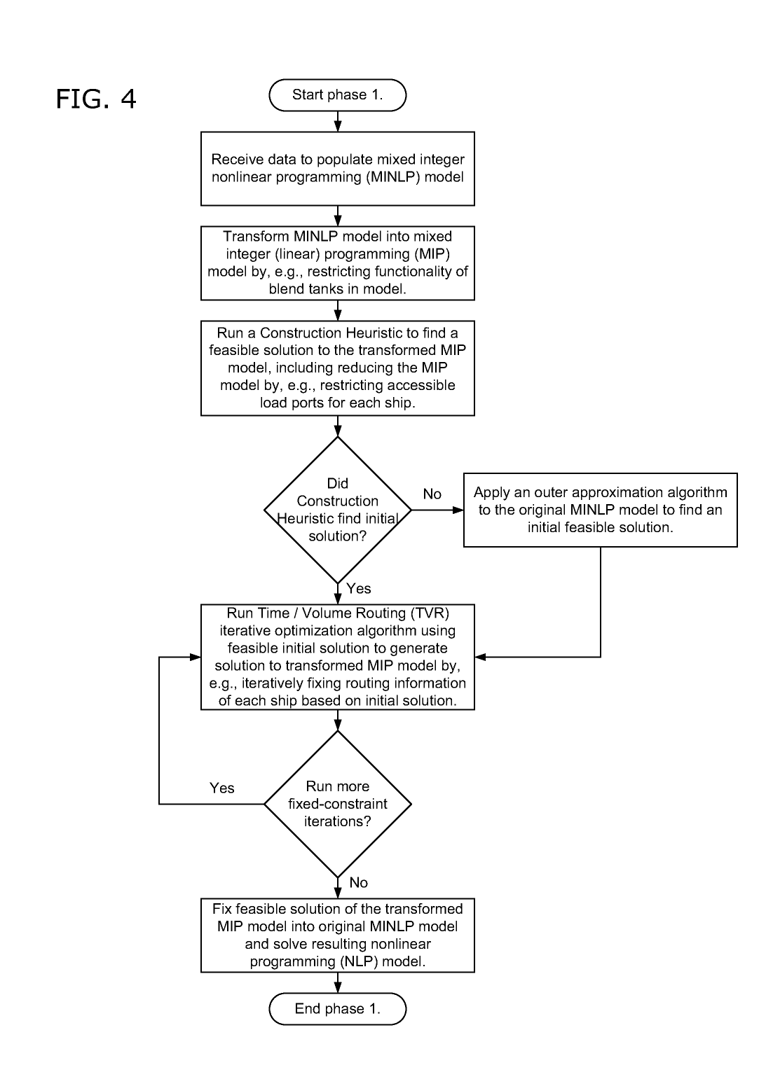

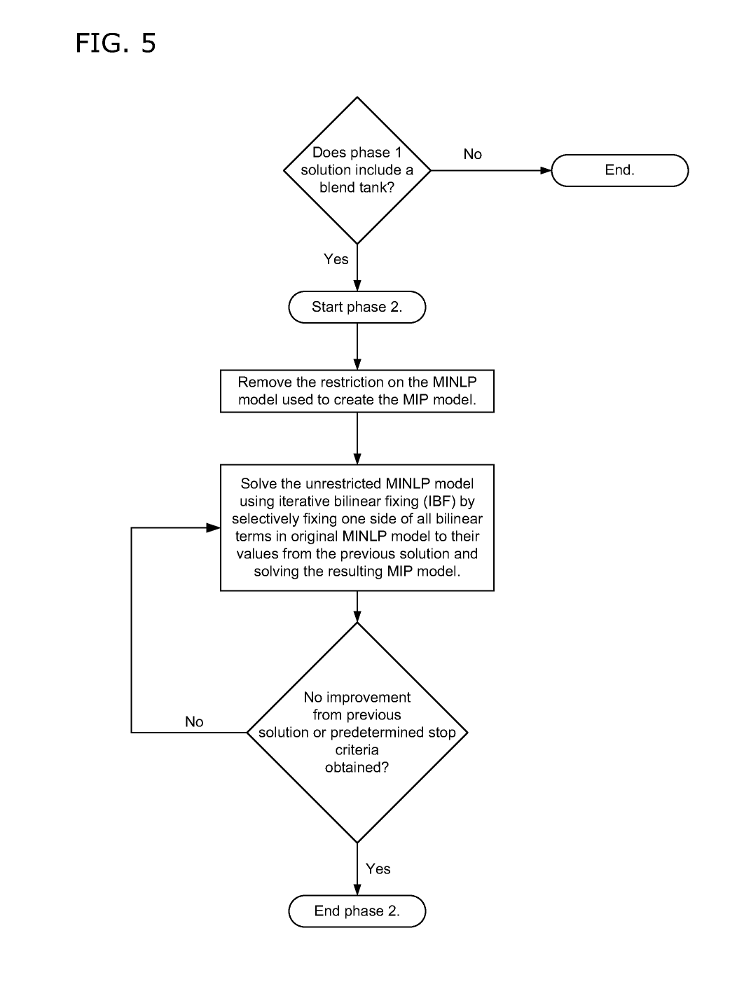

By combining the transformation step, the Construction Heuristic, the Time Volume Routing (TVR) procedure, the solution of an NLP subproblem, and the Iterative Bilinear Fixing (IBF) procedure, an effective optimization based solution method is designed for the problem. The first step in the solution method is to transform the nonlinear nonconvex MINLP METEOROID model into an MILP problem. The solution method then proceeds by solving this MILP problem through a sequence of heuristics. First, the Construction Heuristic is run. If it finds a feasible solution, the TVR algorithm is applied to improve the solution. Upon termination of the TVR procedure, the solution obtained at this point is used to fix all equivalent variables in the MINLP to their values. The resulting NLP is then solved, and the solution is checked to see whether the blend tanks were utilized. If this is the case, the overall algorithm moves to phase 2, and the IBF procedure is instantiated. The latter terminates either with a better solution than what it started with, or returns that solution if it fails to improve it. FIGS. 3 and 4 show flowcharts illustrating the overall algorithm. Time limits may be enforced on the Construction Heuristic, subproblems in both the TVR and IBF procedures in order to make sure the overall procedure terminates in a reasonable amount of time. These time limits can be tuned through computational experiments.

### Time-Space Network Model: Variations for Practical Requirements

Many variations of the model introduced earlier are confronted in practice. The purpose of this section is to discuss how one can incorporate these practical variations into the model. Third party ports are different from user-company owned or operated ports because the supply and demand stream inventory levels are not tracked. For each stream at a third party port, time windows and the amount of available product for loading or discharging for each time window are given. Let T_{ss,k}¹ and T_{ss,k}² represent the beginning and the ending of time window kεK for a supply stream ssεSSⱼ such that jεJ^{L}^{₃} respectively. Let Q_{ss,k}^{3,SS} represent available amount for loading during time window k for third party supply stream ss. Similarly, let T_{ds,k}¹ and T_{ds,k}² represent the beginning and the ending of time window k for a demand stream dsεDSⱼ such that jεJ^{D}^{₃} respectively. Let Q_{ds,k}^{3,DS} represent maximum amount for discharging during time window k for third party demand stream ds. We assume that time windows for a third party stream are mutually exclusive.

$${\sum }_{v ∈ V} {\sum }_{\{ n = ( j , t ) \vert {T}_{ss , k}^{1} \leq t \leq {T}_{ss , k}^{2} \}} {f}_{n , ss , v}^{SS , V} \leq {Q}_{ss , k}^{3 , SS} , ∀ j ∈ {J}^{{L}_{3}} , ∀ ss ∈ {SS}_{j ,} ∀ k ∈ K . \\ {\sum }_{v ∈ V} {\sum }_{ss ∈ SS} {\sum }_{\{ n = ( j , t ) \vert {T}_{ds , k}^{1} \leq t \leq {T}_{ds , k}^{2} \}} {f}_{n , v , ss , ds}^{V , DS} + {\sum }_{{T}_{ds , k}^{1} \leq t \leq {T}_{ds , k}^{2}} {\sum }_{bs ∈ {BS}_{ds}^{IN , DS}} {f}_{bs , ds , t}^{BS , DS} \leq {Q}_{ds , k}^{3 , DS} , \\ ∀ j ∈ {J}^{{D}_{3}} , ∀ ds ∈ {DS}_{j} , ∀ k ∈ K .$$

Spot market streams are an extreme case of third party streams because their time window is essentially the entire time horizon. Like third party streams, inventories are not tracked for spot market streams and there is a maximum amount Q_{ss,t}^{M,SS} for loading or Q_{ds,t}^{M,DS} for discharging for each day at a spot market stream.

$${\sum }_{ds ∈ DS} {f}_{ss , ds , t}^{SS , DS} + {\sum }_{bs ∈ BS} {f}_{ss , bs , t}^{SS , BS} \leq {Q}_{ss , t}^{M , SS} , ∀ ss ∈ {SS}_{j} , j ∈ {J}^{{L}_{PR}} , \\ ∀ t ∈ \{ 1 , 2 , … , T \} , {\sum }_{v ∈ V} {\sum }_{ss ∈ SS} {f}_{n , v , ss , ds}^{V , DS} + {\sum }_{bs ∈ {BS}_{ds}^{IN , DS}} {f}_{bs , ds , t}^{BS , DS} \leq {Q}_{ds , t}^{M , DS} , \\ ∀ j ∈ {J}^{{D}_{SL}} , ∀ ds ∈ {DS}_{j} , ∀ t ∈ \{ 1 , 2 , … , T \} , n = ( j , t ) .$$

A lower limit N^{LBV} and an upper limit N^{UBV} on the number of ships used in the solution can be easily considered in the model.

$${N}^{LBV} \leq {\sum }_{v ∈ V} ( 1 - {x}_{( v , ( 0 , 0 ) , ( 0 , T + 1 ) )} ) \leq {N}^{UBV} .$$

A minimum amount of product M to be transported may be imposed as an optional constraint. The following constraint equation adds such a consideration.

$${\sum }_{v ∈ V} {\sum }_{\{ n = ( j , t ) ∈ {N}^{R} \vert j ∈ {J}^{D} \}} {\sum }_{ds ∈ {DS}_{j}} {\sum }_{ss ∈ SS} {f}_{n , v , ss , ds}^{V , DS} \geq M .$$

For each ship vεV, there may exist a demurrage limit DWᵥ. This is represented by

$${\sum }_{\{ a ∈ {A}_{v}^{D} \}} {x}_{a} \leq {DW}_{v} , ∀ v ∈ V .$$

Each ship vεV may need to load at least PCTᵥ percent of base volume. To satisfy this requirement, we define the set of constraints

$${\sum }_{\{ n = ( j , t ) ∈ {N}^{R} \vert j ∈ {J}^{L} \}} {\sum }_{ss ∈ {SS}_{j}} {f}_{n , ss , v}^{SS , V} \geq {PCT}_{v} {B}_{v} {\sum }_{\{ a = ( v , ( 0 , 0 ) , ( 0 , T + 1 ) ) ∈ A \}} ( 1 - {x}_{a} ) , \\ ∀ v ∈ V .$$

A port may have a special requirement on the minimum amount of time between consecutive loads or discharges. Let port j need at least Tⱼ^{ADJ} amount of time between any consecutive loads or discharges. For each tε{1, 2, . . . , T−Tⱼ^{ADJ}}, the following constraint ensures this requirement, by defining

$${\sum }_{v ∈ V} {\sum }_{\{ n = ( j , {t}^{′} ) ∈ {N}^{R} \vert t \leq {t}^{′} \leq t + {T}_{j}^{ADJ} \}} {z}_{n , v} \leq 1.$$

Inventory holding costs could also be added to the model. Since product may be purchased from third party ports and spot markets, the amount and timing of these purchases can make an impact on such costs. If all the ports are user-company owned ports, it is not necessary to consider inventory holding costs because production and demand profiles are fixed inputs in the model and cannot be controlled as decision variables. Let H^{L} represent the inventory holding cost per unit per day for products at load ports. Let H^{D} represent the inventory holding cost per unit per day for products at discharge ports. Let H^{S} represent the inventory holding cost per unit per day for products on board a ship. Let H^{T}K represent the inventory holding cost per unit per day for products in a blend tank. It should be noted that these values can be easily made product and time specific without adding any additional complexity to the model. The following term is necessary to be added to the objective function in order to consider inventory holding costs.

$$- [ \begin{matrix}\begin{matrix}{H}^{L} {\sum }_{t} {\sum }_{j ∈ {J}^{L} ⋂ {J}^{O}} {\sum }_{ss ∈ {SS}_{j}} {i}_{ss , t}^{SS} + {H}^{S} {\sum }_{t} {\sum }_{v ∈ V} {\sum }_{ss ∈ SS} {I}_{v , ss , t}^{T} + \\ {H}^{D} {\sum }_{t} {\sum }_{j ∈ {J}^{D} ⋂ {J}^{O}} {\sum }_{ds ∈ {DS}_{j}} {I}_{ds , t}^{V} {}_{j}^{}{I}{}_{ds , t}^{} +\end{matrix} \\ {H}^{TK} {\sum }_{t} {\sum }_{j ∈ {J}^{D}} {\sum }_{bs ∈ {BS}_{j}} {I}_{bs , t}\end{matrix} ] .$$

Up to this point, it has been assumed that only spot ships may be used for the transportation of VGO. However, the bulk products can also be delivered by barges, which is accounted for by the model.

There is sometimes an economic opportunity to decide if a ship will be used either as a Panamax or Aframax. Depending on the decision, the economics and restrictions regarding the ship can be quite different. One way to resolve this issue is to solve the problem twice with each option, and choose the better option. Another way to resolve this issue is to incorporate this option as a decision variable in the model. This option can be generalized further. Let V_{du}^{DU} be a subset of V. By enforcing that at most R_{du} ships can be used among ships in V_{du}^{DU}, the option is now incorporated in the model in a more general way. The following constraint ensures that:

$${\sum }_{v ∈ {V}_{du}^{DU}} ( 1 - {x}_{( v , ( 0 , 0 ) , 0 , T + 1 )} ) \leq {R}_{du} .$$

This addendum could affect the performance of the Construction Heuristic.

### Extension to Supply-Side Blend Tanks

The description of the mathematical model and the algorithm previously discussed applied to scenarios where demand-side only blend tanks existed. In this section, we aim to extend the formulation and the algorithm to accommodate supply-side blend tanks as well. In order to do so, new variables must be defined. Let the set BS^{SPL}⊂BS represent the set of blend tanks that exist only on the supply-side. Then, the continuous variable f_{n,v,bs,ds}^{V,BS,DS} with n=(j,t)εN^{R}, jεJ_{D}, bsεBS^{SPL} and dsεDSⱼ represents the discharge amount of blended product bs obtained from some supply-side blend tank for demand stream ds from ship v at time t. Similarly, the continuous variable f_{n,v,bs,bs′}^{V,BS,BS} with n=(j,t)εN^{R}, jεj^{D}^{_{O}}∪J^{L}^{_{O}}, bsεBS^{SPL} and bs′εBS represents the discharge amount of blended product bs obtained from some supply-side blend tank for some blend tank stream bs′ either on the supply or demand side from ship v at time t.

Furthermore, some constraints need to be modified to allow for the additional flexibility of supply side tanks, and we briefly describe some of these constraints. Other constraints can be modified in a similar manner, although we omit the details because this can be done in straightforward fashion.

For instance, the next set of constraints ensures inventory and property-specification balances of blend tank streams at load (supply-side) and discharge (demand-side) ports.

$$\begin{matrix}{i}_{bs , t}^{BS} = {i}_{bs , t - 1}^{BS} + {\sum }_{v ∈ V} {\sum }_{ss ∈ SS} {f}_{n , v , ss , ds}^{V , BS} + {\sum }_{{bs}^{′} \neq bs ∈ {BS}_{bs}^{IN , BS}} {f}_{{bs}^{′} , bs , t - {TT}_{{bs}^{′} , bs}^{BS , BS}}^{BS , BS} + {\sum }_{v ∈ V} {\sum }_{{bs}^{′} ∈ {BS}^{SPL}} {f}_{n , v , {bs}^{′} , bs}^{V , BS , BS} + {\sum }_{ss ∈ {SS}_{{j}^{′} , bs}^{IN , BS} , {j}^{′} ∈ {J}^{{L}_{PR}}} {f}_{ss , bs , t}^{SS , BS} - {\sum }_{{bs}^{′} \neq bs ∈ {BS}_{bs}^{OUT , BS}} {f}_{bs , {bs}^{′} , t}^{BS , BS} - {\sum }_{v ∈ V} {\sum }_{{bs}^{′} ∈ {BS}^{SPL}} {f}_{n , v , bs , {bs}^{′}}^{V , BS , BS} - {\sum }_{v ∈ V} {\sum }_{ds ∈ {DS}_{bs}^{OUT , BS}} {f}_{n , v , bs , ds}^{V , BS , DS} - {\sum }_{ds ∈ {DS}_{bs}^{OUT , BS}} {f}_{bs , ds , t}^{BS , DS} , \\ ∀ n = ( j , t ) ∈ {N}^{R} , ∀ j ∈ {J}^{{D}_{o}} ⋃ {J}^{{L}_{o}} , ∀ bs ∈ {BS}_{j} . & ( 106 ) \\ {s}_{bs , q , t}^{BS} {i}_{bs , t}^{BS} = {s}_{bs , q , t}^{BS} {i}_{bs , t - 1}^{BS} + {\sum }_{v ∈ V} {\sum }_{ss ∈ SS} {S}_{ss , q}^{SS} {f}_{n , v , ss , bs}^{V , BS} + {\sum }_{{bs}^{′} \neq bs ∈ {BS}_{bs}^{IN , BS}} {s}_{{bs}^{′} , q , t - 1 - {TT}_{{bs}^{′} , bs}^{BS , BS}}^{BS} {f}_{{bs}^{′} , q , t - {TT}_{{bs}^{′} , bs}^{BS , BS}}^{BS , BS} + {\sum }_{v ∈ V} {\sum }_{{bs}^{′} ∈ {BS}^{SPL}} {s}_{{bs}^{′} , q , t - 1 - {TT}_{{bs}^{′} , bs}^{BS , BS}}^{BS} {f}_{n , v , {bs}^{′} , bs}^{V , BS , BS} + {\sum }_{ss ∈ {SS}_{{j}^{′} , bs}^{IN , BS} , {j}^{′} ∈ {J}^{{L}_{PR}}} {S}_{ss , q}^{SS} {f}_{ss , bs , t}^{SS , BS} - {\sum }_{{bs}^{′} \neq bs ∈ {BS}_{bs}^{OUT , BS}} {s}_{bs , q , t - 1}^{BS} {f}_{bs , {bs}^{′} , t}^{BS , BS} - {\sum }_{v ∈ V} {\sum }_{{bs}^{′} ∈ {BS}^{SPL}} {s}_{bs , q , t - 1}^{BS} {f}_{n , v , bs , {bs}^{′}}^{V , BS , BS} - {\sum }_{v ∈ V} {\sum }_{ds ∈ {lDS}_{bs}^{OUT , BS}} {s}_{bs , q , t - 1}^{BS} {f}_{n , v , bs , ds}^{V , BS , DS} - {\sum }_{ds ∈ {DS}_{bs}^{OUT , BS}} {s}_{bs , q , t - 1}^{BS} {f}_{bs , ds , t}^{BS , DS} , \\ ∀ n = ( j , t ) ∈ {N}^{R} , ∀ j ∈ {J}^{{D}_{o}} ⋃ {J}^{{L}_{o}} , ∀ bs ∈ {BS}_{j} , ∀ q ∈ Q . & ( 107 )\end{matrix}$$

With regards to the algorithm, the same solution method developed in section 3 can be used here. Note that in phase 1 of the aforementioned method, because no transfer of material can occur between tanks, any phase 1 solution will necessarily have no transfer of material between tanks on the supply-side and tanks on the demand-side (in addition to no movements of material amongst tanks exclusively on the supply or demand side). However, as previously described, we attempt to remedy this drawback in phase 2 of the algorithm.

### Computer Application and Apparatus

In certain embodiments, the present invention is implemented as a computer application that resides on a computer-readable medium. The computer application runs on a conventional computer processor (e.g., a 3 GHz single-processor personal computer). The processor can, but does not have to be, a single standalone processor. The processor can also be a collection of interactive processors connected directly to one another or a collection of interactive processors connected indirectly to one another over a computer network (e.g., a local area network or the internet).

The computer application comprises code that defines calculations, simulations, and math models and, optionally, one or more optimization based solution methods. The application further comprises code that calls upon an optimization solver engine which is integral to, or interfaces with, the application to solve the math models, through an exact method and/or through one or more heuristics. Preferably, the code is written using modeling system software such as AIMMS, GAMS, ILOG OPL, AMPL, or XPress Mosel. However, the code could also be written using any computer programming language including C++. In one embodiment, the application is written using AIMMS and employs an AIMMS user interface. Preferably, the solver is capable of solving linear programming and mixed integer (linear) programming problems. Preferred solvers include CPLEX, XPress, KNITRO and XA.

In a preferred embodiment, data entry and storage is accomplished using an Excel interface and the program is written in the AIMMS modeling language and calls upon a CPLEX solver to solve the math modeling problems in the program using an exact method, or using one or more heuristics, or using a combination thereof. In this embodiment, the program utilizes an AIMMS interface for execution and output. The results can then be transferred (e.g., exported or copied) back to Excel and stored as an Excel file. Alternatively, the results can be stored and managed in AIMMS.

In certain embodiments, the application is configured to provide a solution quickly enough (e.g., in less than thirty minutes) to support decision making in real-time scenarios where business parameters may change quickly and frequent re-optimizations or “what-if” case analysis are needed. A typical complex problem has at least 4 supply locations, at least 4 demand locations, a fleet of at least 10 vehicles, at least one production stream per supply location, at least one demand stream per demand location, and about a month of planning period. In some cases, the complex problem also has at least one spot purchase location and at least one spot sale location.

As an approach to solving the mixed-integer non-linear programming model (MINLP), the present invention may use any suitable relaxation and/or decomposition method known in the art. One such technique is to decompose the MINLP into a mixed-integer linear programming (MILP) subproblem and, optionally, a non-linear programming (NLP) subproblem. Where the MINLP is decomposed into both an MILP subproblem and an NLP subproblem, the resulting MILP and NLP subproblems can then be solved in a cooperative manner (e.g., iteratively).

The MILP subproblem may be formulated by a linear approximation of the MINLP. The resulting MILP subproblem may be solved by any suitable technique known in the art. Where the MILP subproblem is complex and difficult to solve, one or more heuristic algorithms may be used to obtain a sub-optimal, but still usable solution within a reasonable period of time. For example, the MILP subproblem may be solved by a construction heuristic in which the complexity of the model is reduced, and an initial feasible solution is obtained for the reduced MILP subproblem. Typically, the construction heuristic is created by limiting the supply ports and/or demand ports that each available vessel can visit. As explained above, the present invention may also use various other approaches to reduce the complexity of the model by restricting the feasible space. A solver is then used to determine a feasible solution to the reduced model. Because the construction heuristic represents a subset of the more complex modeling problem, the feasible solution to the reduced model is a feasible solution to the more complex problem. If a feasible solution to the reduced model cannot be found, then the full MILP model can be run to find an initial feasible solution.

It may also be necessary to reduce the functionality of the blending tank(s) to ensure that a solution obtained for the MILP is also a solution to the MINLP. One way to do this is to impose a monotonic functionality to the blending tank(s). For example, the monotonic functionality may require that once discharge begins, each blending tank must be fully emptied before accepting new bulk products.

In the preferred embodiment, one or more improvement heuristics are used to improve the initial feasible solution found by the construction heuristic. Preferably, the improvement heuristics include one or more, and preferably multiple, large neighborhood searches. For example, the solution process may comprise a construction heuristic followed by multiple large neighborhood searches. Preferably, each large neighborhood search is employed in an iterative manner until no further improvements in the feasible solution are obtained.

In some embodiments, the solution process uses two improvement heuristics, both of which comprise a large neighborhood search. In this embodiment, the first heuristic is a “Solution Polishing” functionality offered by CPLEX. Although the exact details of the CPLEX Solution Polishing are proprietary to CPLEX, it appears to be a combination of a genetic algorithm and a large neighborhood search. In this embodiment, the second heuristic relaxes the schedule of two vessels in the feasible solution and fixes the remaining vessel schedules in accordance with the feasible solution. Each improvement heuristic is solved by the solver. Each improvement heuristic can be utilized alone or in series. When operated in series, the answer from the first improvement heuristic is used in the next improvement heuristic. Preferably, each improvement heuristic is used multiple times, in an iterative manner, until no further improvement in the feasible solution is obtained.

Optionally, but preferably, the solution from a large neighborhood search can be further improved by running a time and volume optimization. Preferably, the time and volume optimization is automatically invoked each time a specified large neighborhood search is invoked. In a preferred embodiment, where a series of two or more large neighborhood search heuristics are employed, the time and volume optimization is run on the answer obtained by the last heuristic in the series. The time and volume optimization fixes all the routes in accordance with the solution from the large neighborhood search, so that the routes are no longer a variable. However, the timing of the stops and how much is loaded and discharged is relaxed and then solved to optimality. This often improves the solution. If the solution obtained for the MILP subproblem thus far includes the use of a blending tank, the solution may be further improved by iterative bilinear fixing of the original MINLP as described above.

In certain embodiments, the method may further comprise formulating a non-linear programming (NLP) subproblem by fixing the integer components of the MINLP (e.g., the binary decision variables) based on the solution obtained for the MILP subproblem. The NLP subproblem may be solved using any suitable NLP solver known in the art. In some cases, where the solution thus far includes the use of a blending tank, the NLP subproblem solution may be further improved by iterative bilinear fixing of the original MINLP as described above.

In some cases, one or more of the various algorithms described above may be used in an iterative manner to arrive at a solution (whether optimal or near optimal). The iterations may be continued until there are no further improvements in the solution.

### Closing

While this description uses a variety of examples and illustrative equations to fully illustrate the concepts behind the invention, the invention is by no means so limited. Various modifications, adjustments and applications of the disclosed invention will be apparent to those of ordinary skill in the art and are covered to the extent they fall within the scope of the appended claims.

### NOMENCLATURE USED

A all arcs, where A=∪_{vεV}Aᵥ
Aᵥ all arcs for vessel vεV
A^{D} all demurrage arcs, where A^{D}=∪_{vεV}Aᵥ^{D}
Aᵥ^{D} all demurrage arcs for vessel vεV
A^{T} all travel arcs, where A^{T}=∪_{vεV}Aᵥ^{T}
Aᵥ^{T} all travel arcs for vessel vεV
BS all blend tank streams, where BS=∪_{jεJ}_{^{D}}BSⱼ
BSⱼ all blend tank streams at port jεJ
BS_{bs}^{IN,BS} all blend tank streams bs′≠bs that can discharge into blend tank stream bsεBS, where BS_{bs}^{IN,BS}⊂BS
BS_{ds}^{IN,DS} all blend tank streams that can discharge into demand stream dsεDS, where BS_{ds}^{IN,DS}⊂BS
BS_{bs}^{OUT,BS} all blend tank streams bs′≠bs that blend tank stream bsεBS can discharge into, where BS_{bs}^{OUT,BS}⊂BS
DS all demand streams
DSⱼ all demand streams at port jεJ
DS_{bs}^{OUT,BS} all demand steams that blend tank stream bsεBS can discharge into, where DS_{bs}^{OUT,BS}⊂DS
J all ports
J^{D} all discharge ports
J^{DL} all ports with draft limits
J^{L} all load ports
J^{M} all ports for spot sale markets
J^{O} all ports owned and/or operated by ExxonMobil
J^{TK} all blend tank ports
J³ all ports operated by third parties
N all nodes
N^{R} all regular nodes, where N^{R}={(j,t):jεJ, tε{1, 2, . . . , T}}
PR all spot purchase markets
PR_{bs}^{IN,BS} all spot purchase market streams ssεPR that can discharge into blend tank stream bsεBS, where PR_{bs}^{IN,BS}⊂PR
PR_{ds}^{IN,DS} all spot purchase market streams ssεPR that can discharge into demand stream dsεDS, where PR_{ds}^{IN,DS}⊂PR
Q all tracked properties
Q̅ properties qεQ whose higher specifications increase value.
Q properties qεQ whose lower specifications increase value
SS all supply streams
SSⱼ all supply streams at port jεJ
SL all spot sale markets
SL_{bs}^{OUT,BS} all spot sale market streams that can accept blend tank stream bsεBS, where SL_{bs}^{OUT,BS}⊂SL
V all vessels available for transportation
V^{CHART} all previously chartered vessels
δ⁺(n) all arcs that have node nεN as their tail not
δ⁻(n) all arcs that have node nεN as their head node {1, 2, . . . , T} all days from day 1 to day T

### Indices

a arc aεA
bs blend tank stream bsεBS
ds demand stream dsεDS
j port jεJ
n arc nεN
ss spot purchase market stream ssεPR
q property qεQ
sl spot sale market stream slεSL
ss supply stream ssεSS
t day tε{1, 2, . . . , T}
v vessel vεV

### Parameters

Bᵥ basis amount of product (PC tons)
Cₐ the cost of using arc a
C_{jj′} flat rate for traveling from port jεJ to port j′εJ
D_{ds,t} amount of consumption of demand stream dsεDS from time t−1 to time t
DLᵥⱼₜ^{IN} inlet draft limit
DLᵥⱼₜ^{OUT} outlet draft limit
DR_{c} demurrage rate
Fⱼ^{MIN} minimum total amount of load (or discharge) that must be lifted (or discharged) at port jεJ
Fⱼ^{MAX} maximum total amount of load (or discharge) that can be lifted (or discharged) at port jεJ
F_{bs,t}^{MIN,BS} minimum total amount of blend tank stream that must be discharged (or discharged) at port jεJ
F_{bs,t}^{MAX,BS} maximum total amount of blend tank stream that can be discharged (or discharged) at port jεJ
I_{bs,0}^{BS} initial inventory of blend tank stream bsεBS (on the beginning day)
I_{ds,0}^{DS} initial inventory of demand stream dsεDS (on the beginning day)
I_{bs,t}^{MAX,BS} at time t maximum inventory possible of blend tank stream bsεBS at time t
I_{ds,t}^{MAX,DS} maximum inventory possible of demand stream dsεDS at time t
I_{ss,t}^{MAX,SS} maximum inventory possible of supply stream ssεSS at time t
Iᵥ^{MAX,V} maximum amount of product vessel vεV may carry
I_{bs,t}^{MIN,BS} minimum inventory required of blend tank stream bsεBS at time t
I_{ds,t}^{MIN,DS} minimum inventory required of demand stream dsεDS at time t
I_{ss,t}^{MIN,SS} minimum inventory required of supply stream ssεSS at time t
I_{ss,0}^{SS} initial inventory of supply stream ssεSS (on the beginning day)
I_{v,ss,0}^{V} initial vessel vεV inventory for supply stream ss (on the beginning day)
LBAVG_{bs,q,t} daily-average lower bound on property specification qεQ for blend tank stream bsεBS at time t
LBH_{bs,q}^{BS} hard lower bound on the level of property qεQ in discharged product for blend tank stream bsεBS
LBH_{ds,q}^{DS} hard lower bound on the level of property qεQ in discharged product for demand stream dsεDS
LBS_{bs,q}^{BS} soft lower bound on the level of property qεQ in discharged product for blend tank stream bsεBS
LBH_{ds,q}^{DS} soft lower bound on the level of property qεQ in discharged product for demand stream dsεDS
OVR_{c} overage rate
P_{SS,T} amount of production of supply stream ssεSS from time t−1 to time t
S_{ss,q}^{PR} specification for property qεQ for spot purchase market stream ssεPR
S_{ss,q}^{SS} specification of property qεQ for supply stream ssεSS
SAV_{bs,q,0}^{BS} specification adjusted value of blend tank inventory at t=0
STD_{bs,q}^{BS} standard specification of blend tank stream bsεBS for property qεQ
STD_{ds,q}^{DS} standard specification of demand stream dsεDS for property qεQ
T planning horizon
T_{jj′} travel times between ports j and j′
Tᵥ^{CHART} time at which vessel vεV^{CHART} becomes available
Uⱼ maximum number of times any vessel vεV can load or discharge at any port jεJ
UBAVG_{bs,q,t} daily-average upper bound on property specification qεQ for blend tank stream bsεBS at time t
UBH_{bs,q}^{BS} hard upper bound on the level of property qεQ in discharged product for blend tank stream bsεBS
UBH_{ds,q}^{DS} hard upper bound on the level of property qεQ in discharged product for demand stream dsεDS
UBS_{bs,q}^{DS} soft upper bound on the level of property qεQ in discharged product for blend tank stream bsεBS
UBS_{ds,q}^{DS} soft upper bound on the level of property qεQ in discharged product for demand stream dsεDS
VBU_{q} value base unit
VLₛₛ value of supply stream ssεSS per unit at its supply port
VLB_{bs}^{BS,FIN} base value per unit of final (at time t=T) blend tank inventory for blend tank stream bsεBS
VLB_{bs}^{BS,INIT} base value per unit of initial (at time t=0) blend tank inventory for blend tank stream bsεBS
VLB_{ds}^{DS} base value per unit of discharged product for demand stream dsεDS
VS_{bs,q}^{BS} the amount that the value per unit of blend tank inventory for blend tank stream bsεBS increases or decreases by, relative to VLB_{bs}^{BS}, depending on whether qε Q̅ or qεQ
VS_{ds,q}^{DS} the amount that the value per unit of discharged product for demand stream dsεDS increases or decreases by, relative to VLB_{ds}^{DS}, depending on whether qε Q̅ or qεQ
WSᵥ world scale multiplier

### Continuous Variables

f_{bs′,bs,t}^{BS,BS} discharge amount of product from blend tank stream bs′εBSⱼ, bs′≠bs, jεJ^{D} to blend tank stream bsεBS at time t
f_{bs,ds,t}^{BS,DS} discharge amount of product from blend tank stream bsεBS_{ds}^{IN,DS} to demand stream dsεDSⱼ, jεJ^{D} at time t
f_{bs,sl,t}^{BS,SL} loading amount of product (via barge) from blend tank stream bsεBS to spot sale market stream slεSL_{bs}^{OUT,BS} at time t
f_{ss,bs,t}^{PR,BS} discharge amount of product (via barge) from spot purchase market stream ssεPR_{bs}^{IN,BS} to blend tank stream bsεBS at time t
f_{ss,ds,t}^{PR,DS} discharge amount of product (via barge) from spot purchase market stream ssεPR_{ds}^{IN,DS} to demand stream dsεDS at time t
f_{n,ss,v}^{SS,V} loading amount of product at node n=(j,t)εN^{R}, jεJ^{L} from supply stream ssεSSⱼ to vessel vεV at time t
f_{n,v,ss,bs}^{V,BS} discharge amount of ssεSS product at node n=(j,t)εN^{R}, jεJ^{D} from vessel vεV to blend tank stream bsεBS at time t
f_{n,v,ss,ds}^{V,ds} discharge amount of ssεSS product at node n=(j,t)εN^{R}, jεJ^{D} from vessel vεV to demand stream dsεDSⱼ at time t
i_{bs,t}^{BS} inventory level of blend tank stream bsεBS at time t
i_{ds,t}^{DS} inventory level of demand stream dsεDS at time t
I_{ss,t}^{SS} inventory level of supply stream ssεSS at time t
i_{v,ss,t}^{V} inventory level of product ssεSS on vessel vεV at time t
o_{a,v} amount of overage for each travel arc aεAᵥ^{T} and vεV is equal to oᵥ if arc a used. Otherwise o_{a,v} takes a value of zero
o_{c} the largest amount of overage of vessel vεV's voyage
s_{bs,q,t}^{BS} property specification qεQ of blend tank stream bsεBS at time t and dsεDSⱼ
sav_{bs,q,T}^{BS} specification adjusted value based on property qεQ of discharged product for blend tank inventory of blend tank stream bsεBS_{ds}^{IN,DS} at time T
sav_{bs,ds,q,t}^{BS,DS} specification adjusted value based on property qεQ of discharged product for demand stream dsεDS by blend tank stream bsεBS_{ds}^{IN,DS} at time t
sav_{n,v,ds,q}^{V,DS} specification adjusted value based on property qεQ of discharged product for demand stream dsεDS by vessel vεV where n=(j,t)εN^{R}

### Binary Variables

xₐ is equal to 1 if vessel vεV uses arc aεA, and takes the value 0 otherwise.
w_{n,bs} is equal to 1 each node n=(j,t)εN^{R}, jεJ^{D} if no outputs occur from blend tank bsεBSⱼ at time t, and takes a value of 0 if no inputs occur into blend tank bsεBSⱼ at time t
y_{bs,ds,t} is equal to 1 if property specifications s_{bs,q,t-1} of product discharged from blend tank stream bsεBS into demand stream dsεDS at time t meet the allowable range of property specification of demand stream ds x_{n,v} is equal to 1 at each node n=(j,t)εN^{R} if vessel vεV loads product(s) from port jεJ^{L} or discharges product(s) to port jεJ^{D} at time t

What is claimed is:

1. A method for transporting bulk products, comprising:
(I) receiving a data set comprising:
(a) an identification of a plurality of supply locations and a plurality of demand locations;
(b) for each supply location, identification of one or more supply streams of bulk products and the monetary values of the bulk products from the supply stream;
(c) for each demand location, identification of one or more demand streams of bulk products and the monetary values of the bulk products that meet the property specification requirements of the demand stream;
(d) identification of a fleet of vehicles for carrying bulk products between supply locations and demand locations;
(e) data relating to the capacity of each vehicle in the fleet;
(f) data relating to the costs for transporting bulk products from the supply locations to the demand locations; and
(g) identification of one or more blending tanks located at a demand location or a supply location for receiving bulk product from a vehicle and discharging bulk product to a demand stream;
(II) using the data set to populate a mathematical model that comprises an objective function for net profit margin and a plurality of constraints;
wherein the constraints include one or more non-linear terms relating to the quantity or property of blending tank content;
(III) obtaining a solution to the mathematical model for maximizing the objective function for net profit margin; and
(IV) physically transporting one or more bulk products based on the solution to the mathematical model.

2. The method of claim 1, wherein the net profit margin calculation comprises the sum of the monetary values of the bulk products discharged directly to the demand streams from the vehicles, the sum of the monetary values of the bulk products discharged from each blending tank to a demand stream, minus the sum of the monetary values of the bulk products loaded from the supply streams, minus costs related to the transportation of the bulk products between the supply locations and the demand locations, minus costs related to the use of each blending tank.

3. The method of claim 1, wherein the mathematical model is a mixed integer non-linear programming (MINLP) model.

4. The method of claim 3, wherein obtaining a solution to the MINLP model comprises transforming the MINLP model into a mixed integer linear programming (MILP) model subproblem and solving the MILP model subproblem.

5. The method of claim 4, wherein solving the MILP model subproblem comprises imposing as a constraint, a monotonic functionality to each blending tank.

6. The method of claim 5, wherein the monotonic functionality requires that once discharge begins, each blending tank must be fully emptied before accepting new bulk products.

7. The method of claim 4, wherein solving the MILP model subproblem further comprises reducing the model complexity and obtaining an initial feasible solution to the reduced MILP model subproblem.

8. The method of claim 7, wherein reducing the model complexity comprises restricting the accessible supply locations or demand locations for one or more vehicles.

9. The method of claim 7, further comprising obtaining an improved solution to the initial feasible solution by fixing the routes of one or more vehicles based on the initial feasible solution and applying a large neighborhood search to the MILP model subproblem.

10. The method of claim 4, further comprising using the solution of the MILP model subproblem to formulate a non-linear programming (NLP) model subproblem by fixing the integer components of the MINLP model based on the solution obtained for the MILP model subproblem

11. The method of claim 10, wherein the one or more non-linear terms are bilinear terms, and further comprising, if the NLP model subproblem solution uses a blending tank, obtaining an improved solution to the MINLP model by steps comprising:
(a) removing the constraint imposing monotonic functionality to each blending tank; and
(b) fixing one side of all bilinear terms in the MINLP model and solving the resulting MILP model.

12. The method of claim 2, wherein the objective function for net profit margin further comprises the sum of the costs for leasing a blending tank as a subtraction.

13. The method of claim 2, wherein the objective function for net profit margin further comprises the sum of the costs for discharging bulk products from a blending tank to a demand stream as a subtraction.

14. The method of claim 2, wherein the objective function for net profit margin further comprises a value adjustment based on the specifications required by the demand stream.

15. The method of claim 1, wherein the model further comprises decision variables for one or more of: vehicle choice, routing, load amounts, discharge amounts, timing, blending tank leasing, and bulk product blending.

16. The method of claim 1, wherein at least one demand location requires a bulk product having a different property specification than the bulk products available from one or more of the supply streams.

17. The method of claim 16, further comprising using the solution to determine a blending plan for blending one or more bulk products to form a blended bulk product that meets the different property specification requirement for a demand stream.

18. The method of claim 17, further comprising, according to the blending plan, physically transferring one or more bulk products into a blending tank containing another bulk product, and blending the bulk products to form the blended bulk product.

19. The method of claim 2, wherein the objective function for net profit margin further comprises the sum of the specification adjusted valuations of the discharged bulk products.

20. The method of claim 1, wherein each vehicle is a vessel, each supply location is a supply port, and each demand location is a demand port.

21. The method of claim 1, wherein the fleet of vehicles is heterogeneous.

22. The method of claim 1, wherein the constraints include one or more of the following: terms relating to load amounts, terms relating to discharge amounts, terms relating to bulk product availability, terms relating to bulk product specifications, terms relating to vehicle capacity, and terms relating to property specification.

23. The method of claim 1, wherein the data set further comprises data relating to one or more of the following for one or more blending tanks: tank capacity, bulk product property specification, loading restrictions, discharge restrictions, tank lease duration, and tank lease costs.

24. The method of claim 2, wherein the objective function further comprises the sum of the inventory holding costs.

25. The method of claim 3, wherein the MINLP model is solved by decomposing into a mixed integer linear programming (MILP) model subproblem and a non-linear programming (NLP) model subproblem;
wherein the MILP model is solved first and the solution to the MILP model is used to define the NLP model.

26. The method of claim 10, wherein the one or more non-linear terms are bilinear terms, and further comprising, if the NLP model subproblem solution uses a blending tank, obtaining an improved solution to the MINLP model by steps comprising:
(a) removing the constraint imposing monotonic functionality to each blending tank; and
(b) fixing one variable in each of the bilinear terms in the MINLP model and solving the resulting MILP model.

27. An computer apparatus for determining the transportation of bulk products, comprising:
(I) a memory device storing a data file containing:
(a) an identification of a plurality of supply locations and a plurality of demand locations;
(b) for each supply location, identification of one or more supply streams of bulk products and the monetary values of the bulk products from the supply stream;
(c) for each demand location, identification of one or more demand streams of bulk products and the monetary values of the bulk products that meet the property specification requirements of the demand stream;
(d) identification of a fleet of vehicles for carrying bulk products between supply locations and demand locations;
(e) data relating to the capacity of each vehicle in the fleet;
(f) data relating to the costs for transporting bulk products from the supply locations to the demand locations; and
(g) identification of one or more blending tanks located at a demand location or a supply location for receiving bulk product from a vehicle and discharging bulk product to a demand stream;
(II) a modeling application executable by the optimization apparatus to populate a mathematical model using the data file, the mathematical model comprising an objective function for net profit margin and a plurality of constraints;
wherein the constraints include one or more non-linear terms relating to the quantity or property of blending tank content;
(III) a solver engine operable by the optimization apparatus to obtain a solution to the mathematical model for maximizing the objective function for net profit margin.

28. A program storage device readable by a machine, tangibly embodying a program of instructions executable by the machine to perform method steps for determining the transportation of bulk products, said method steps comprising:
(I) reading a data file comprising:
(a) an identification of a plurality of supply locations and a plurality of demand locations;
(b) for each supply location, identification of one or more supply streams of bulk products and the monetary values of the bulk products from the supply stream;
(c) for each demand location, identification of one or more demand streams of bulk products and the monetary values of the bulk products that meet the property specification requirements of the demand stream;
(d) identification of a fleet of vehicles for carrying bulk products between supply locations and demand locations;
(e) data relating to the capacity of each vehicle in the fleet;
(f) data relating to the costs for transporting bulk products from the supply locations to the demand locations; and
(g) identification of one or more blending tanks located at a demand location or a supply location for receiving bulk product from a vehicle and discharging bulk product to a demand stream;
(II) using the data file to populate a mathematical model that comprises an objective function for net profit margin and a plurality of constraints;
wherein the constraints include one or more non-linear terms relating to the quantity or property of blending tank content;
(III) obtaining a solution to the mathematical model for maximizing the objective function for net profit margin.
